(19) United States
(12) Patent Application Publication
(10) Pub. No.: US 2026/0363244 A1
(43) Pub. Date: Nov. 19, 2026

(54) HERBICIDAL COMPOSITIONS COMPRISING URACILS

(71) Applicant: BASF SE, Ludwigshafen (DE)

(72) Inventors: Liliana Parra Rapado, Limburgerhof (DE); Tobias Seiser, Ludwigshafen (DE); Dustin Franklin Lewis, Apex, NC (US); Markus Kordes, Ludwigshafen (DE); Marc Heinrich, Ludwigshafen (DE)

(21) Appl. No.: 19/130,973

(22) PCT Filed: Nov. 13, 2023
(86) PCT No.: PCT/EP2023/081558

§ 371 Date: May 19, 2025

(30) Foreign Application Priority Data
Nov. 23, 2022 (EP) 22208988.0

(51) Int. Cl. A01N 43/80; A01N 43/54; A01P 13/00

(52) U.S. Cl. CPC A01N 43/80; A01N 43/54; A01P 13/00

(57) ABSTRACT

The present invention relates to herbicidal compositions comprising at least one uracil of formula (I) wherein the variables are defined as given in the specification, and at least one isoxazoline of formula (II), wherein the variables are defined as given in the specification.

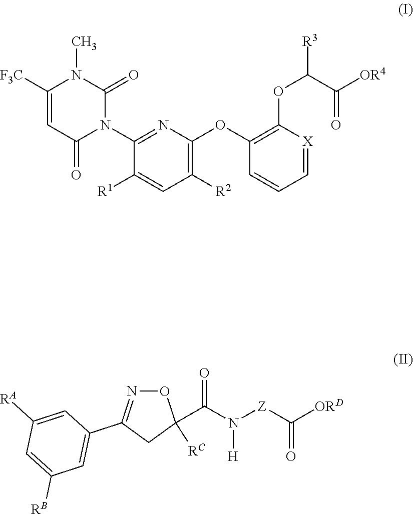

The present invention relates to herbicidal compositions comprising at least one uracil of formula (I) and at least one isoxazoline of formula (II).

In the case of crop protection compositions, it is desirable in principle to increase the specific activity of an active compound and the reliability of the effect. It is particularly desirable for the crop protection composition to control the harmful plants effectively, but at the same time to be compatible with the useful plants in question. Also desirable is a broad spectrum of activity allowing the simultaneous control of harmful plants. Frequently, this cannot be achieved using a single herbicidally active compound.

With many highly effective herbicides, there is the problem that their compatibility with useful plants, in particular dicotyledonous crop plants, such as cotton, oilseed rape and graminaceous plants, such as barley, millet, corn, rice, wheat and sugar cane, is not always satisfactory, i.e. in addition to the harmful plants, the crop plants, too, are damaged on a scale which cannot be tolerated. By reducing the application rates, the useful plants are spared; however, naturally, the extent of the control of harmful plants decreases, too.

Frequently, it is a problem that herbicides can only be applied within a narrow time frame in order to achieve the desired herbicidal action, which time frame may be unpredictably influenced by weather conditions.

It is known that special combinations of different specifically active herbicides result in enhanced activity of an herbicide component in the sense of a synergistic effect. In this manner, it is possible to reduce the application rates of herbicidally active compounds required for controlling the harmful plants.

Furthermore, it is known that in some cases joint application of specifically acting herbicides with organic active compounds, some of which may also have herbicidal activity, allows better crop plant compatibility to be achieved. In these cases, the active compounds act as antidotes or antagonists and are also referred to as safeners, since they reduce or even prevent damage to the crop plants.

Uracils of formula (I), herbicidal compositions comprising the same as well as processes for preparing such uracils of formula (I) have been described in WO 2017/202768.

Herbicidal compositions comprising isoxazolines of formula (II) have been described for example in WO 2020/114932, WO 2021/01273 and WO 2022/24486.

It is an object of the present invention to provide herbicidal compositions which are highly active against unwanted harmful plants. At the same time, the compositions should have good compatibility with useful plants. In addition, the compositions according to the invention should have a broad spectrum of activity.

This and further objects are achieved by the herbicidal compositions below.

Accordingly, the present invention relates to herbicidal compositions comprising:
A) at least one uracil of formula (I)

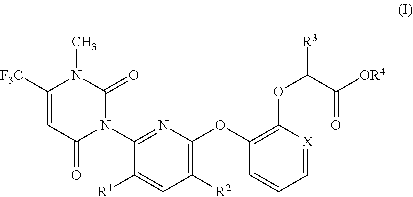

wherein
R¹ is H or halogen;
R² is halogen;
R³ is H or CH₃;
R⁴ is H or C₁-C₆-alkyl; and
X is C or N;
including their agriculturally acceptable salts;
and
B) at least one isoxazoline of formula (II)

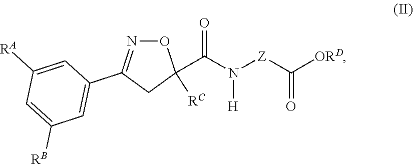

wherein
R^{A} is halogen;
R^{B} is halogen;
R^{C} is CH₃, CH═CH₂ or OCH₃;
R^{D} is H or C₁-C₃-alkyl;
Z is selected from Z-1 or Z-2:

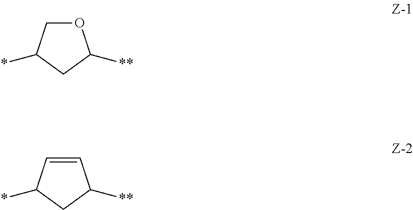

wherein
* denotes the point of attachment to the amino group;
** denotes the point of attachment to the carbonyl group;
   including their agriculturally acceptable salts.

The invention relates in particular to compositions in the form of herbicidal active agrochemical compositions comprising a herbicidally effective amount of an active compound combination comprising at least one uracil of formula (I) and at least one isoxazoline of formula (II) as defined above, and also at least one liquid and/or solid carrier and/or one or more surfactants and, if desired, one or more further auxiliaries customary for agrochemical compositions.

The invention also relates to compositions in the form of a agrochemical composition formulated as a 1-component composition comprising an active compound combination comprising at least one uracil of formula (I) and at least one isoxazoline of formula (II), and at least one solid or liquid carrier and/or one or more surfactants and, if desired, one or more further auxiliaries customary for agrochemical compositions.

The invention also relates to compositions in the form of a agrochemical composition formulated as a 2-component composition comprising a first component comprising at least one uracil of formula (I), a solid or liquid carrier and/or one or more surfactants, and a second component comprising at least one isoxazoline of formula (II), a solid or liquid carrier and/or one or more surfactants, where additionally both components may also comprise further auxiliaries customary for agrochemical compositions.

Surprisingly, the compositions according to the invention comprising at least one uracil of formula (I) and at least one isoxazoline of formula (II) have better herbicidal activity, i.e. better activity against harmful plants, than would have been expected based on the herbicidal activity observed for the individual compounds, or a broader activity spectrum.

The herbicidal activity to be expected for mixtures based on the individual compound can be calculated using Colby's formula (see below). If the activity observed exceeds the expected additive activity of the individual compounds, synergism is said to be present.

Moreover, the time frame, within which the desired herbicidal action can be achieved, may be expanded by the compositions according to the invention comprising at least one uracil of formula (I) and at least one isoxazoline of formula (II). This allows a more flexibly timed application of the compostions according to the present invention in comparison with the single compounds.

The compositions according to the invention comprising both at least one uracil of formula (I) and at least one isoxazoline of formula (II) also have better compatibility with useful plants.

The invention furthermore relates to a method for controlling unwanted vegetation, in particular where crop plants are cultivated.

The invention also relates to a method for the desiccation or defoliation of plants.

As used herein, the terms “undesirable vegetation” and “harmful plants” are synonyms.

If the isoxazolines of formula (II) as described herein can form geometrical isomers, for example E/Z isomers, it is possible to use both, the pure isomers and mixtures thereof, in the compositions according to the invention.

If the uracils of formula (I) or the isoxazolines of formula (II) as described herein have one or more centers of chirality and, as a consequence, are present as enantiomers or diastereomers, it is possible to use both, the pure enantiomers and diastereomers and their mixtures, in the compositions according to the invention.

If the uracils of formula (I) or the isoxazolines of formula (II) as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diethylammonium, diisopropylammonium, trimethylammonium, triethylammonium, tris(isopropyl)ammonium, heptylammonium, dodecylammonium, tetradecylammonium, tetramethylammonium, tetraethylammonium, tetrabutylammonium, 2-hydroxyethylammonium (olamine salt), 2-(2-hydroxyeth-1-oxy)eth-1-ylammonium (diglycolamine salt), di(2-hydroxyeth-1-yl)ammonium (diolamine salt), tris(2-hydroxyethyl)ammonium (trolamine salt), tris(2-hydroxypropyl)ammonium, benzyltrimethylammonium, benzyltriethylammonium, N,N,N-trimethylethanolammonium (choline salt), furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium, and finally the salts of polybasic amines such as N,N-bis-(3-aminopropyl)methylamine and diethylenetriamine.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

Further embodiments of the present invention are evident from the claims, the description and the examples. It is to be understood that the features mentioned above and still to be illustrated below of the subject matter of the invention can be applied not only in the combination given in each case but also in other combinations, without leaving the scope of the invention.

The organic moieties mentioned in the definition of the variables R¹, R², R⁴, R^{A}, R^{B} and R^{D}, are—like the term halogen—collective terms for individual enumerations of the individual group members.

The term halogen denotes in each case fluorine, chlorine, bromine or iodine.

All hydrocarbon chains, i.e. all alkyl can be straight-chain or branched, the prefix Cₙ-Cₘ denoting in each case the possible number of carbon atoms in the group.

Examples of such meanings are:
C₁-C₃-alkyl: CH₃, C₂H₅, n-propyl, and CH(CH₃)₂;
C₁-C₄-alkyl: C₁-C₃-alkyl as mentioned above and also, n-butyl, CH(CH₃)—C₂H₅, CH₂—CH(CH₃)₂, and C(CH₃)₃;
C₁-C₆-alkyl: C₁-C₄-alkyl as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methyl-pentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl; The preferred embodiments of the invention mentioned herein below should be understood as being preferred either independently from each other or in combination with one another.

According to a preferred embodiment of the invention preference is given to those uracils of formula (I), wherein the variables, either independently of one another or in combination with one another, have the following meanings:

Preferred are the uracils of formula (I), wherein
R¹ is F or Cl;
   particularly preferred F.

Preferred are the uracils of formula (I), wherein
R² is Cl or Br;
   particularly preferred Cl.

Preferred are the uracils of formula (I), wherein
R³ is H.

Preferred are the uracils of formula (I), wherein
R⁴ is H, CH₃ or C₂H₅;
   particularly preferred H or C₂H₅;
   more preferred is H;
   also more preferred is C₂H.

Preferred are the uracils of formula (I), wherein
X is C;
   also preferred is N.

According to a preferred embodiment of the invention, the composition comprises as component A at least one, preferably exactly one, uracil of formula (I.1) (corresponds to uracil of formula (I) wherein R¹ is F, R² is Cl, R³ is H, R⁴ is H and X is C):

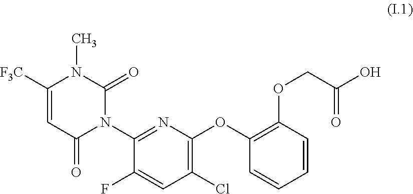 [SMILES: Cn1c(C(F)(F)F)cc(=O)n(-c2nc(Oc3ccccc3OCC(=O)O)c(Cl)cc2F)c1=O]

According to a preferred embodiment of the invention, the composition comprises as component A at least one, preferably exactly one, uracil of formula (I.2) (corresponds to uracil of formula (I) wherein R¹ is F, R² is Cl, R³ is H, R⁴ is CH₃ and X is C):

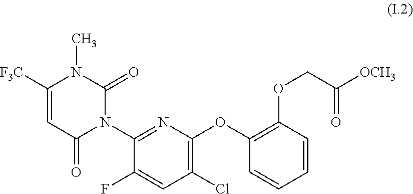 [SMILES: COC(=O)COc1ccccc1Oc1nc(-n2c(=O)cc(C(F)(F)F)n(C)c2=O)c(F)cc1Cl]

According to a preferred embodiment of the invention, the composition comprises as component A at least one, preferably exactly one, uracil of formula (I.3) (corresponds to uracil of formula (I) wherein R¹ is F, R² is Cl, R³ is H, R⁴ is C₂H₅ and X is C):

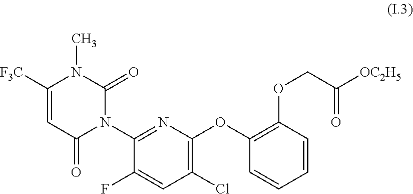 [SMILES: CCOC(=O)COc1ccccc1Oc1nc(-n2c(=O)cc(C(F)(F)F)n(C)c2=O)c(F)cc1Cl]

According to a preferred embodiment of the invention, the composition comprises as component A at least one, preferably exactly one, uracil of formula (I.4) (corresponds to uracil of formula (I) wherein R¹ is F, R² is Cl, R³ is H, R⁴ is H and X is N):

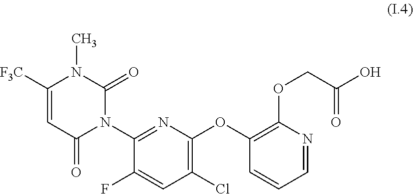 [SMILES: Cn1c(C(F)(F)F)cc(=O)n(-c2nc(Oc3cccnc3OCC(=O)O)c(Cl)cc2F)c1=O]

According to a preferred embodiment of the invention, the composition comprises as component A at least one, preferably exactly one, uracil of formula (I.5) (corresponds to uracil of formula (I) wherein R¹ is F, R² is Cl, R³ is H, R⁴ is CH₃ and X is N):

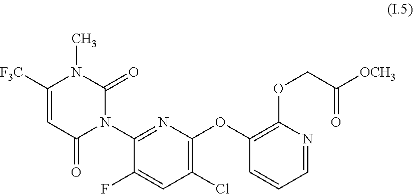 [SMILES: COC(=O)COc1ncccc1Oc1nc(-n2c(=O)cc(C(F)(F)F)n(C)c2=O)c(F)cc1Cl]

According to a preferred embodiment of the invention, the composition comprises as component A at least one, preferably exactly one, uracil of formula (I.6) (corresponds to uracil of formula (I) wherein R¹ is F, R² is Cl, R³ is H, R⁴ is C₂H₅ and X is N):

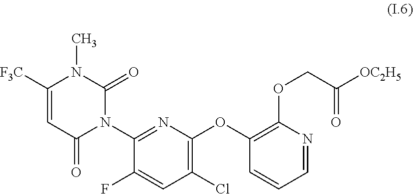 [SMILES: CCOC(=O)COc1ncccc1Oc1nc(-n2c(=O)cc(C(F)(F)F)n(C)c2=O)c(F)cc1Cl]

According to a preferred embodiment of the invention, the composition comprises as component A at least one, preferably exactly one, uracil of formula (I.7) (corresponds to uracil of formula (I) wherein R¹ is F, R² is Br, R³ is H, R⁴ is H and X is N):

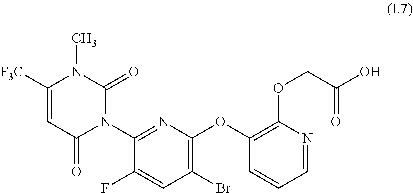 [SMILES: Cn1c(C(F)(F)F)cc(=O)n(-c2nc(Oc3cccnc3OCC(=O)O)c(Br)cc2F)c1=O]

According to a preferred embodiment of the invention, the composition comprises as component A at least one, preferably exactly one, uracil of formula (I.8) (corresponds to uracil of formula (I) wherein R¹ is F, R² is Br, R³ is H, R⁴ is CH₃ and X is N):

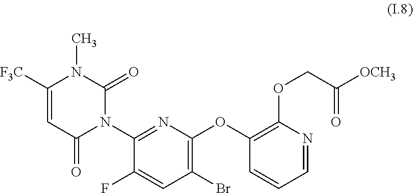 [SMILES: COC(=O)COc1ncccc1Oc1nc(-n2c(=O)cc(C(F)(F)F)n(C)c2=O)c(F)cc1Br]

According to a preferred embodiment of the invention, the composition comprises as component A at least one, preferably exactly one, uracil of formula (I.9) (corresponds to uracil of formula (I) wherein R¹ is F, R² is Br, R³ is H, R⁴ is C₂H₅ and X is N):

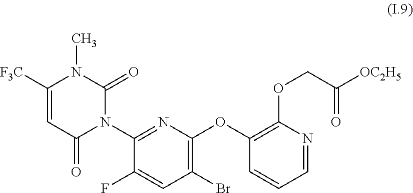 [SMILES: CCOC(=O)COc1ncccc1Oc1nc(-n2c(=O)cc(C(F)(F)F)n(C)c2=O)c(F)cc1Br]

According to a preferred embodiment of the invention preference is given to those isoxazolines of formula (II), wherein the variables, either independently of one another or in combination with one another, have the following meanings:

Preferred are the isoxazolines of formula (II), wherein
R^{A} is F or Cl;
   particularly preferred F.

Preferred are the isoxazolines of formula (II), wherein
R^{B} is F or Cl;
   particularly preferred F.

Also preferred are the isoxazolines of formula (II), wherein
R^{C} is CH₃ or CH═CH₂;
   particularly preferred CH₃;
also particularly preferred CH═CH₂.

Also preferred are the isoxazolines of formula (II), wherein
R^{D} is C₁-C₃-alkyl;
   particularly preferred CH₃;
also preferably is H or CH₃;
   particularly preferred H;
also particularly preferred CH₃.

Also preferred are the isoxazolines of formula (II), wherein
Z is Z-1

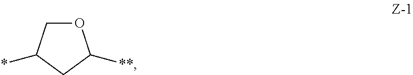

wherein *denotes the point of attachment to the amino group;
   ** denotes the point of attachment to the carbonyl group.

Also preferred are the isoxazolines of formula (II), wherein
Z is Z-2

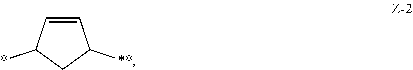

wherein *denotes the point of attachment to the amino group;
   ** denotes the point of attachment to the carbonyl group.

According to another preferred embodiment of the invention, the composition comprises as component B at least one, preferably exactly one, isoxazoline of formula (II.1) (corresponds to isoxazolines of formula (II) wherein R^{A} and R^{B} are F, R^{C} is CH═CH₂, R^{D} is CH₃ and Z is Z-1:

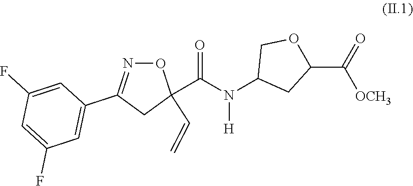 [SMILES: C=CC1(C(=O)NC2COC(C(=O)OC)C2)CC(c2cc(F)cc(F)c2)=NO1]

According to another preferred embodiment of the invention, the composition comprises as component B at least one, preferably exactly one, isoxazoline of formula (II.1.cis) (corresponds to isoxazolines of formula (II) wherein R^{A} and R^{B} are F, R^{C} is CH═CH₂, R^{D} is CH₃ and Z is Z-1, wherein the substituents at Z-1 are “cis” to each other):

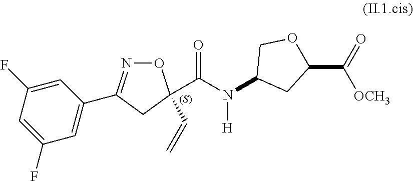

According to another preferred embodiment of the invention, the composition comprises as component B at least one isoxazoline of formula (II.1.cis.A), which corresponds to methyl (2S,4S)-4-[[(5S)-3-(3,5-difluorophenyl)-5-vinyl-4H-isoxazole-5-carbonyl]amino]tetrahydrofuran-2-carboxylate (CAS 2254813-53-9):

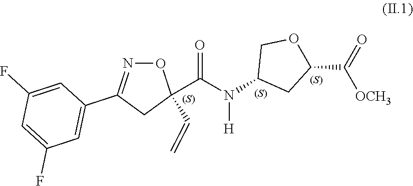

According to another preferred embodiment of the invention, the composition comprises as component B at least one isoxazoline of formula (II.1.cis.B), which corresponds to methyl (2R,4R)-4-[[(5S)-3-(3,5-difluorophenyl)-5-vinyl-4H-isoxazole-5-carbonyl]amino]tetrahydrofuran-2-carboxylate (CAS 2254752-21-9):

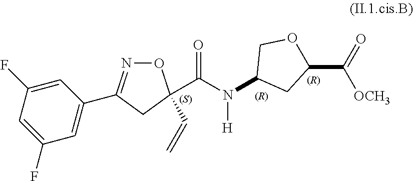

The isoxazolines of formulae (II.1.cis.A) and (II.1.cis.B) as described herein include also different forms of each diastereomer, such as crystalline forms as described for example in WO 2021/185806.

According to another preferred embodiment of the invention the composition contains as component B the isoxazoline of formula (II.1.cis.A).

According to another particular preferred embodiment of the invention the composition contains as component B the isoxazoline of formula (II.1.cis.B).

According to another preferred embodiment of the invention, the composition comprises as component B a mixture of diastereomers comprising 30-60% of the isoxazoline of formula (II.1.cis.A) and 70-40% of the isoxazoline of formula (II.1.cis.B), both as herein defined.

According to another preferred embodiment of the invention, the composition comprises as component B a mixture of diastereomers consisting of 30-60% of the isoxazoline of formula (II.1.cis.A) and 70-40% of the isoxazoline of formula (II.1.cis.B), both as herein defined.

According to another preferred embodiment of the invention, the composition comprises as component B a mixture of diastereomers comprising 40-50% of the isoxazoline of formula (II.1.cis.A) and 60-50% of the isoxazoline of formula (II.1.cis.B), both as herein defined.

According to another preferred embodiment of the invention, the composition comprises as component B a mixture of diastereomers consisting of 40-50% of the isoxazoline of formula (II.1.cis.A) and 60-50% of the isoxazoline of formula (II.1.cis.B), both as herein defined.

According to another preferred embodiment of the invention, the composition comprises as component B a mixture of diastereomers comprising 50-60% of the isoxazoline of formula (II.1.cis.A) and 50-40% of the isoxazoline of formula (II.1.cis.B), both as herein defined.

According to another preferred embodiment of the invention, the composition comprises as component B a mixture of diastereomers consisting of 50-60% of the isoxazoline of formula (II.1.cis.A) and 50-40% of the isoxazoline of formula (II.1.cis.B), both as herein defined.

According to another preferred embodiment of the invention, the composition comprises as component B a racemic mixture comprising the isoxazoline of formula (II.1.cis.A) and the isoxazoline of formula (II.1.cis.B), both as herein defined. Such specific component B is also named “ISOX-8” (see table ISOX below), which refers to the isoxazoline (II.1.cis), wherein (II.1.cis.A)+(II.1.cis.B) are present in a ratio of 50:50.

According to another preferred embodiment of the invention, the composition comprises as component B ISOX-8, i.e. a racemic mixture consisting of the isoxazoline of formula (II.1.cis.A) and the isoxazoline of formula (II.1.cis.B), both as herein defined.

According to another preferred embodiment of the invention, the composition comprises as component B at least one, preferably exactly one, isoxazoline of formula (II.2) (corresponds to isoxazolines of formula (II) wherein R^{A} and R^{B} are F, R^{C} is CH₃, R^{D} is CH₃ and Z is Z-1:

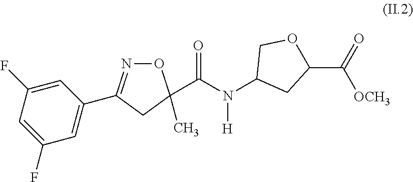 [SMILES: COC(=O)C1CC(NC(=O)C2(C)CC(c3cc(F)cc(F)c3)=NO2)CO1]

According to another preferred embodiment of the invention, the composition comprises as component B at least one, preferably exactly one, isoxazoline of formula (II.2.cis) (corresponds to isoxazolines of formula (II) wherein R^{A} and R^{B} are F, R^{C} is CH₃, R^{D} is CH₃ and Z is Z-1, wherein the substituents at Z-1 are “cis” to each other):

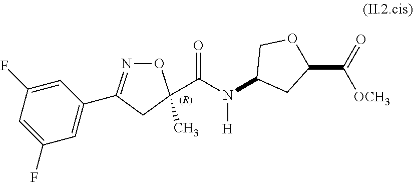

According to another preferred embodiment of the invention, the composition comprises as component B at least one isoxazoline of formula (II.2.cis.A), which corresponds to methyl (2S,4S)-4-[[(5R)-3-(3,5-difluorophenyl)-5-methyl-4H-isoxazole-5-carbonyl]amino]tetrahydro-furan-2-carboxylate:

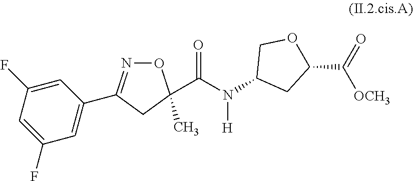 [SMILES: COC(=O)[C@@H]1C[C@H](NC(=O)[C@@]2(C)CC(c3cc(F)cc(F)c3)=NO2)CO1]

According to another preferred embodiment of the invention, the composition comprises as component B at least one isoxazoline of formula (II.2.cis.B), which corresponds to methyl (2R,4R)-4-[[(5R)-3-(3,5-difluorophenyl)-5-methyl-4H-isoxazole-5-carbonyl]amino]tetrahydro-furan-2-carboxylate:

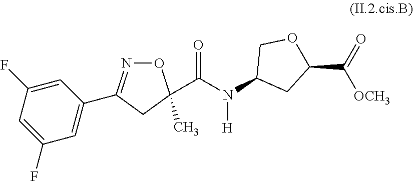 [SMILES: COC(=O)[C@H]1C[C@@H](NC(=O)[C@@]2(C)CC(c3cc(F)cc(F)c3)=NO2)CO1]

According to another preferred embodiment of the invention, the composition comprises as component B a mixture of diastereomers comprising 30-60% of the isoxazoline of formula (II.2.cis.A) and 70-40% of the isoxazoline of formula (II.2.cis.B), both as herein defined.

According to another preferred embodiment of the invention, the composition comprises as component B a mixture of diastereomers consisting of 30-60% of the isoxazoline of formula (II.2.cis.A) and 70-40% of the isoxazoline of formula (II.2.cis.B), both as herein defined.

According to another preferred embodiment of the invention, the composition comprises as component B a mixture of diastereomers comprising 40-50% of the isoxazoline of formula (II.2.cis.A) and 60-50% of the isoxazoline of formula (II.2.cis.B), both as herein defined.

According to another preferred embodiment of the invention, the composition comprises as component B a mixture of diastereomers consisting of 40-50% of the isoxazoline of formula (II.2.cis.A) and 60-50% of the isoxazoline of formula (II.2.cis.B), both as herein defined.

According to another preferred embodiment of the invention, the composition comprises as component B a mixture of diastereomers comprising 50-60% of the isoxazoline of formula (II.2.cis.A) and 50-40% of the isoxazoline of formula (II.2.cis.B), both as herein defined.

According to another preferred embodiment of the invention, the composition comprises as component B a mixture of diastereomers consisting of 50-60% of the isoxazoline of formula (II.2.cis.A) and 50-40% of the isoxazoline of formula (II.2.cis.B), both as herein defined.

According to another preferred embodiment of the invention, the composition comprises as component B a racemic mixture comprising the isoxazoline of formula (II.2.cis.A) and the isoxazoline of formula (II.2.cis.B), both as herein defined.

According to another preferred embodiment of the invention, the composition comprises as component B a racemic mixture consisting of the isoxazoline of formula (II.2.cis.A) and the isoxazoline of formula (II.2.cis.B), both as herein defined.

According to another preferred embodiment of the invention, the composition comprises as component B at least one, preferably exactly one, isoxazoline of formula (II.3) (corresponds to isoxazolines of formula (II) wherein R^{A} and R^{B} are F, R^{C} is CH═CH₂, R^{D} is OH and Z is Z-1:

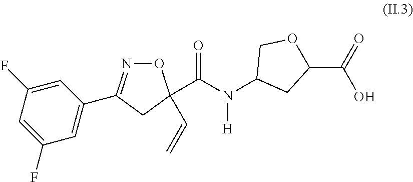 [SMILES: C=CC1(C(=O)NC2COC(C(=O)O)C2)CC(c2cc(F)cc(F)c2)=NO1]

According to another preferred embodiment of the invention, the composition comprises as component B at least one, preferably exactly one, isoxazoline of formula (II.3.cis) (corresponds to isoxazolines of formula (II) wherein R^{A} and R^{B} are F, R^{C} is CH═CH₂, R^{D} is OH and Z is Z-1, wherein the substituents at Z-1 are “cis” to each other):

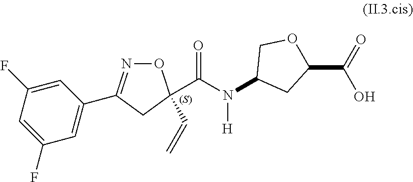

According to another preferred embodiment of the invention, the composition comprises as component B at least one isoxazoline of formula (II.3.cis.A), which corresponds to (2S,4S)-4-[[(5S)-3-(3,5-difluorophenyl)-5-vinyl-4H-isoxazole-5-carbonyl]amino]tetrahydrofuran-2-carboxylic acid):

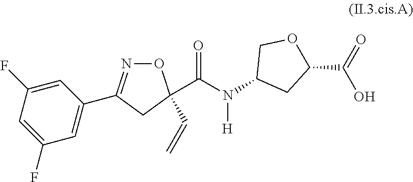 [SMILES: C=C[C@]1(C(=O)N[C@@H]2CO[C@H](C(=O)O)C2)CC(c2cc(F)cc(F)c2)=NO1]

According to another preferred embodiment of the invention, the composition comprises as component B at least one isoxazoline of formula (II.3.cis.B), which corresponds to (2R,4R)-4-[[(5S)-3-(3,5-difluorophenyl)-5-vinyl-4H-isoxazole-5-carbonyl]amino]tetrahydrofuran-2-carboxylic acid:

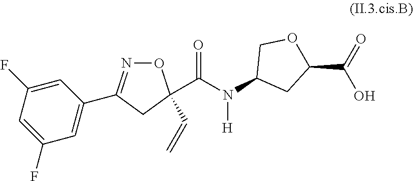 [SMILES: C=C[C@]1(C(=O)N[C@H]2CO[C@@H](C(=O)O)C2)CC(c2cc(F)cc(F)c2)=NO1]

According to another preferred embodiment of the invention, the composition comprises as component B a mixture of diastereomers comprising 30-60% of the isoxazoline of formula (II.3.cis.A) and 70-40% of the isoxazoline of formula (II.3.cis.B), both as herein defined.

According to another preferred embodiment of the invention, the composition comprises as component B a mixture of diastereomers consisting of 30-60% of the isoxazoline of formula (II.3.cis.A) and 70-40% of the isoxazoline of formula (II.3.cis.B), both as herein defined.

According to another preferred embodiment of the invention, the composition comprises as component B a mixture of diastereomers comprising 40-50% of the isoxazoline of formula (II.3.cis.A) and 60-50% of the isoxazoline of formula (II.3.cis.B), both as herein defined.

According to another preferred embodiment of the invention, the composition comprises as component B a mixture of diastereomers consisting of 40-50% of the isoxazoline of formula (II.3.cis.A) and 60-50% of the isoxazoline of formula (II.3.cis.B), both as herein defined.

According to another preferred embodiment of the invention, the composition comprises as component B a mixture of diastereomers comprising 50-60% of the isoxazoline of formula (II.3.cis.A) and 50-40% of the isoxazoline of formula (II.3.cis.B), both as herein defined.

According to another preferred embodiment of the invention, the composition comprises as component B a mixture of diastereomers consisting of 50-60% of the isoxazoline of formula (II.3.cis.A) and 50-40% of the isoxazoline of formula (II.3.cis.B), both as herein defined.

According to another preferred embodiment of the invention, the composition comprises as component B a racemic mixture comprising the isoxazoline of formula (II.3.cis.A) and the isoxazoline of formula (II.3.cis.B), both as herein defined.

According to another preferred embodiment of the invention, the composition comprises as component B a racemic mixture consisting of the isoxazoline of formula (II.3.cis.A) and the isoxazoline of formula (II.3.cis.B), both as herein defined.

According to another preferred embodiment of the invention, the composition comprises as component B at least one, preferably exactly one, isoxazoline of formula (II.4) (corresponds to isoxazolines of formula (II) wherein R^{A} and R^{B} are F, R^{C} is CH₃, R^{D} is OH and Z is Z-1:

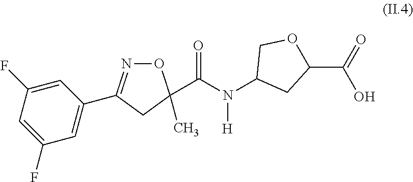 [SMILES: CC1(C(=O)NC2COC(C(=O)O)C2)CC(c2cc(F)cc(F)c2)=NO1]

According to another preferred embodiment of the invention, the composition comprises as component B at least one, preferably exactly one, isoxazoline of formula (II.4.cis) (corresponds to isoxazolines of formula (II) wherein R^{A} and R^{B} are F, R^{C} is CH₃, R^{D} is OH and Z is Z-1, wherein the substituents at Z-1 are “cis” to each other):

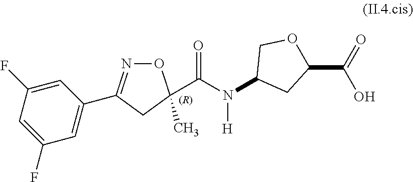

According to another preferred embodiment of the invention, the composition comprises as component B at least one isoxazoline of formula (II.4.cis.A), which corresponds to (2S,4S)-4-[[(5R)-3-(3,5-difluorophenyl)-5-methyl-4H-isoxazole-5-carbonyl]amino]tetrahydrofuran-2-carboxylic acid:

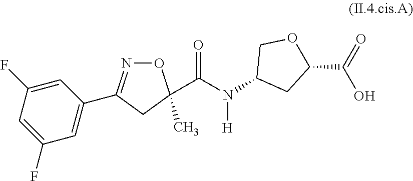 [SMILES: C[C@]1(C(=O)N[C@@H]2CO[C@H](C(=O)O)C2)CC(c2cc(F)cc(F)c2)=NO1]

According to another preferred embodiment of the invention, the composition comprises as component B at least one isoxazoline of formula (II.4.cis.B), which corresponds to (2R,4R)-4-[[(5R)-3-(3,5-difluorophenyl)-5-methyl-4H-isoxazole-5-carbonyl]amino]tetrahydrofuran-2-carboxylic acid:

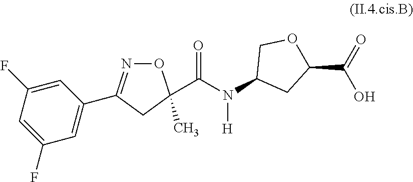 [SMILES: C[C@]1(C(=O)N[C@H]2CO[C@@H](C(=O)O)C2)CC(c2cc(F)cc(F)c2)=NO1]

According to another preferred embodiment of the invention, the composition comprises as component B a mixture of diastereomers comprising 30-60% of the isoxazoline of formula (II.4.cis.A) and 70-40% of the isoxazoline of formula (II.4.cis.B), both as herein defined.

According to another preferred embodiment of the invention, the composition comprises as component B a mixture of diastereomers consisting of 30-60% of the isoxazoline of formula (II.4.cis.A) and 70-40% of the isoxazoline of formula (II.4.cis.B), both as herein defined.

According to another preferred embodiment of the invention, the composition comprises as component B a mixture of diastereomers comprising 40-50% of the isoxazoline of formula (II.4.cis.A) and 60-50% of the isoxazoline of formula (II.4.cis.B), both as herein defined.

According to another preferred embodiment of the invention, the composition comprises as component B a mixture of diastereomers consisting of 40-50% of the isoxazoline of formula (II.4.cis.A) and 60-50% of the isoxazoline of formula (II.4.cis.B), both as herein defined.

According to another preferred embodiment of the invention, the composition comprises as component B a mixture of diastereomers comprising 50-60% of the isoxazoline of formula (II.4.cis.A) and 50-40% of the isoxazoline of formula (II.4.cis.B), both as herein defined.

According to another preferred embodiment of the invention, the composition comprises as component B a mixture of diastereomers consisting of 50-60% of the isoxazoline of formula (II.4.cis.A) and 50-40% of the isoxazoline of formula (II.4.cis.B), both as herein defined.

According to another preferred embodiment of the invention, the composition comprises as component B a racemic mixture comprising the isoxazoline of formula (II.4.cis.A) and the isoxazoline of formula (II.4.cis.B), both as herein defined.

According to another preferred embodiment of the invention, the composition comprises as component B a racemic mixture consisting of the isoxazoline of formula (II.4.cis.A) and the isoxazoline of formula (II.4.cis.B), both as herein defined.

According to another preferred embodiment of the invention, the composition comprises as component B at least one, preferably exactly one, isoxazoline of formula (II.5) (corresponds to isoxazolines of formula (II) wherein R^{A} and R^{B} are F, R^{C} is CH═CH₂, R^{D} is CH₃ and Z is Z-2:

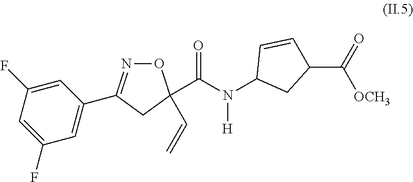 [SMILES: C=CC1(C(=O)NC2C=CC(C(=O)OC)C2)CC(c2cc(F)cc(F)c2)=NO1]

According to another preferred embodiment of the invention, the composition comprises as component B at least one, preferably exactly one, isoxazoline of formula (II.5.cis) (corresponds to isoxazolines of formula (II) wherein R^{A} and R^{B} are F, R^{C} is CH═CH₂, R^{D} is CH₃ and Z is Z-2, wherein the substituents at Z-2 are “cis” to each other):

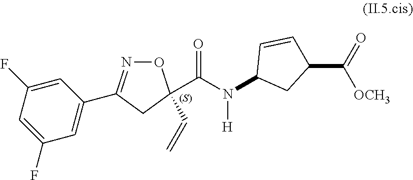

According to another preferred embodiment of the invention, the composition comprises as component B at least one, preferably exactly one, isoxazoline of formula (II.5.cis.A), which corresponds to methyl (1R,4S)-4-[[(5S)-3-(3,5-difluorophenyl)-5-vinyl-4H-isoxazole-5-carbonyl]amino]cyclopent-2-ene-1-carboxylate:

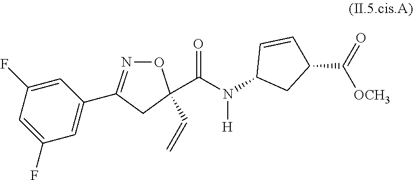 [SMILES: C=C[C@]1(C(=O)N[C@@H]2C=C[C@H](C(=O)OC)C2)CC(c2cc(F)cc(F)c2)=NO1]

According to another preferred embodiment of the invention, the composition comprises as component B at least one, preferably exactly one isoxazoline of formula (II.5.cis.B), which corresponds to methyl (1S,4R)-4-[[(5S)-3-(3,5-difluorophenyl)-5-vinyl-4H-isoxazole-5-carbonyl]amino]cyclopent-2-ene-1-carboxylate:

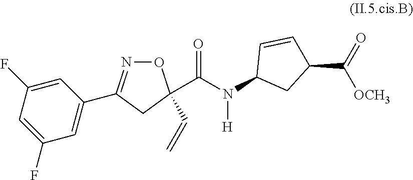 [SMILES: C=C[C@]1(C(=O)N[C@H]2C=C[C@@H](C(=O)OC)C2)CC(c2cc(F)cc(F)c2)=NO1]

According to another preferred embodiment of the invention, the composition comprises as component B a racemic mixture comprising the isoxazoline of formula (II.5.cis.A) and the isoxazoline of formula (II.5.cis.B), both as herein defined.

According to another preferred embodiment of the invention, the composition comprises as component B a racemic mixture consisting of the isoxazoline of formula (II.5.cis.A) and the isoxazoline of formula (II.5.cis.B), both as herein defined.

According to another preferred embodiment of the invention, the composition comprises as component B at least one, preferably exactly one, isoxazoline of formula (II.6) (corresponds to isoxazolines of formula (II) wherein R^{A} and R^{B} are F, R^{C} is CH₃, R^{D} is CH₃ and Z is Z-2:

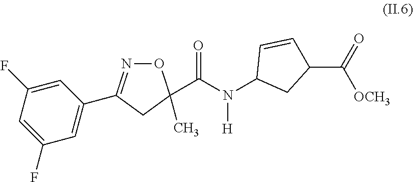 [SMILES: COC(=O)C1C=CC(NC(=O)C2(C)CC(c3cc(F)cc(F)c3)=NO2)C1]

According to another preferred embodiment of the invention, the composition comprises as component B at least one, preferably exactly one, isoxazoline of formula (II.6.cis) (corresponds to isoxazolines of formula (II) wherein R^{A} and R^{B} are F, R^{C} is CH₃, R^{D} is CH₃ and Z is Z-2, wherein the substituents at Z-2 are “cis” to each other):

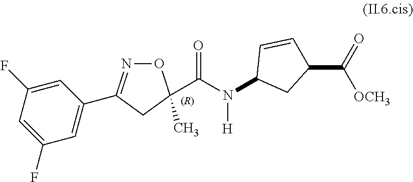

According to another preferred embodiment of the invention, the composition comprises as component B at least one, preferably exactly one, isoxazoline of formula (II.6.cis.A), which corresponds to methyl (1R,4S)-4-[[(5R)-3-(3,5-difluorophenyl)-5-methyl-4H-isoxazole-5-carbonyl]amino]cyclopent-2-ene-1-carboxylate:

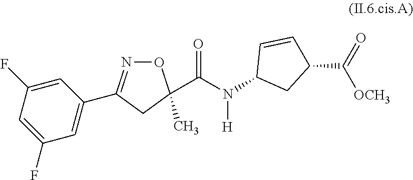 [SMILES: COC(=O)[C@H]1C=C[C@@H](NC(=O)[C@@]2(C)CC(c3cc(F)cc(F)c3)=NO2)C1]

According to another preferred embodiment of the invention, the composition comprises as component B at least one, preferably exactly one, isoxazoline of formula (II.6.cis.B), which corresponds to methyl (1S,4R)-4-[[(5R)-3-(3,5-difluorophenyl)-5-methyl-4H-isoxazole-5-carbonyl]amino]cyclopent-2-ene-1-carboxylate:

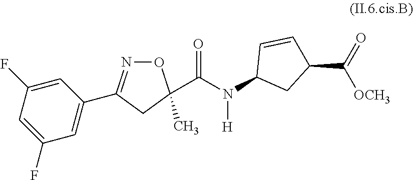 [SMILES: COC(=O)[C@@H]1C=C[C@H](NC(=O)[C@@]2(C)CC(c3cc(F)cc(F)c3)=NO2)C1]

According to another preferred embodiment of the invention, the composition comprises as component B a racemic mixture comprising the isoxazoline of formula (II.6.cis.A) and the isoxazoline of formula (II.6.cis.B), both as herein defined.

According to another preferred embodiment of the invention, the composition comprises as component B a racemic mixture consisting of the isoxazoline of formula (II.6.cis.A) and the isoxazoline of formula (II.6.cis.B), both as herein defined.

According to another preferred embodiment of the invention, the composition comprises as component B at least one, preferably exactly one, isoxazoline of formula (II.7) (corresponds to isoxazolines of formula (II) wherein R^{A} and R^{B} are F, R^{C} is CH═CH₂, R^{D} is OH and Z is Z-2:

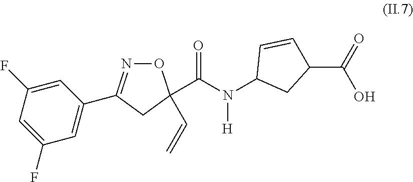 [SMILES: C=CC1(C(=O)NC2C=CC(C(=O)O)C2)CC(c2cc(F)cc(F)c2)=NO1]

According to another preferred embodiment of the invention, the composition comprises as component B at least one, preferably exactly one, isoxazoline of formula (II.7.cis) (corresponds to isoxazolines of formula (II) wherein R^{A} and R^{B} are F, R^{C} is CH═CH₂, R^{D} is OH and Z is Z-2, wherein the substituents at Z-2 are “cis” to each other):

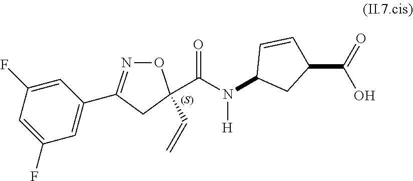

According to another preferred embodiment of the invention, the composition comprises as component B at least one, preferably exactly one, isoxazoline of formula (II.7.cis.A), which corresponds to (1R,4S)-4-[[(5S)-3-(3,5-difluorophenyl)-5-vinyl-4H-isoxazole-5-carbonyl]amino]cyclopent-2-ene-1-carboxylic acid:

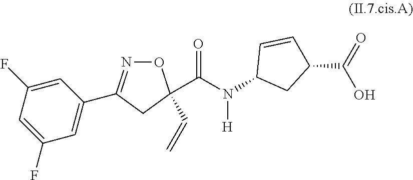 [SMILES: C=C[C@]1(C(=O)N[C@@H]2C=C[C@H](C(=O)O)C2)CC(c2cc(F)cc(F)c2)=NO1]

According to another preferred embodiment of the invention, the composition comprises as component B at least one, preferably exactly one, isoxazoline of formula (II.7.cis.B), which corresponds to (1S,4R)-4-[[(5S)-3-(3,5-difluorophenyl)-5-vinyl-4H-isoxazole-5-carbonyl]amino]cyclopent-2-ene-1-carboxylic acid:

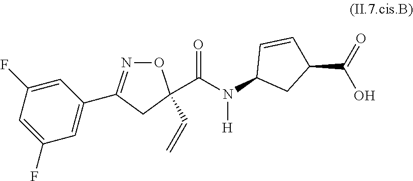 [SMILES: C=C[C@]1(C(=O)N[C@H]2C=C[C@@H](C(=O)O)C2)CC(c2cc(F)cc(F)c2)=NO1]

According to another preferred embodiment of the invention, the composition comprises as component B a racemic mixture comprising the isoxazoline of formula (II.7.cis.A) and the isoxazoline of formula (II.7.cis.B), both as herein defined.

According to another preferred embodiment of the invention, the composition comprises as component B a racemic mixture consisting of the isoxazoline of formula (II.7.cis.A) and the isoxazoline of formula (II.7.cis.B), both as herein defined.

According to another preferred embodiment of the invention, the composition comprises as component B at least one, preferably exactly one, isoxazoline of formula (II.8) (corresponds to isoxazolines of formula (II) wherein R^{A} and R^{B} are F, R^{C} is CH₃, R^{D} is OH and Z is Z-2:

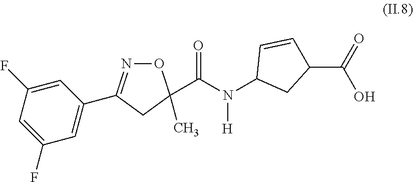 [SMILES: CC1(C(=O)NC2C=CC(C(=O)O)C2)CC(c2cc(F)cc(F)c2)=NO1]

According to another preferred embodiment of the invention, the composition comprises as component B at least one, preferably exactly one, isoxazoline of formula (II.8.cis) (corresponds to isoxazolines of formula (II) wherein R^{A} and R^{B} are F, R^{C} is CH₃, R^{D} is OH and Z is Z-2, wherein the substituents at Z-2 are “cis” to each other):

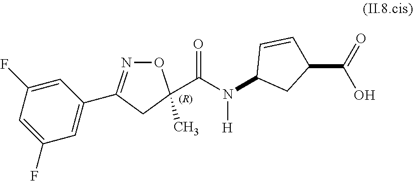

According to another preferred embodiment of the invention, the composition comprises as component B at least one, preferably exactly one, isoxazoline of formula (II.8.cis.A), which corresponds to (1R,4S)-4-[[(5R)-3-(3,5-difluorophenyl)-5-methyl-4H-isoxazole-5-carbonyl]amino]cyclopent-2-ene-1-carboxylic acid:

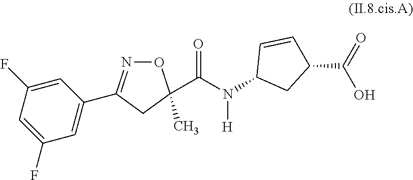 [SMILES: C[C@]1(C(=O)N[C@@H]2C=C[C@H](C(=O)O)C2)CC(c2cc(F)cc(F)c2)=NO1]

According to another preferred embodiment of the invention, the composition comprises as component B at least one, preferably exactly one, isoxazoline of formula (II.8.cis.B), which corresponds to (1S,4R)-4-[[(5R)-3-(3,5-difluorophenyl)-5-methyl-4H-isoxazole-5-carbonyl]amino]cyclopent-2-ene-1-carboxylic acid:

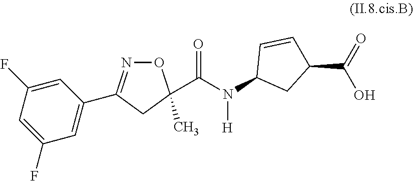 [SMILES: C[C@]1(C(=O)N[C@H]2C=C[C@@H](C(=O)O)C2)CC(c2cc(F)cc(F)c2)=NO1]

According to another preferred embodiment of the invention, the composition comprises as component B a racemic mixture comprising the isoxazoline of formula (II.8.cis.A) and the isoxazoline of formula (II.8.cis.B), both as herein defined.

According to another preferred embodiment of the invention, the composition comprises as component B a racemic mixture consisting of the isoxazoline of formula (II.8.cis.A) and the isoxazoline of formula (II.8.cis.B), both as herein defined.

Especially preferred isoxazolines of the formula (II) which, as component B, are constituent of the composition according to the invention, are the isoxazolines of formulae (II.1.cis), (II.5.cis) and (II.8.cis) as defined above and listed below:
(II.1.cis): methyl cis-4-[[(5S)-3-(3,5-difluorophenyl)-5-vinyl-4H-isoxazole-5-carbonyl]-amino]-tetrahydrofuran-2-carboxylate;
(II.5.cis): methyl cis-4-[[(5S)-3-(3,5-difluorophenyl)-5-vinyl-4H-isoxazole-5-carbonyl]-amino]cyclopent-2-ene-1-carboxylate;
(II.8.cis): cis-4-[[(5R)-3-(3,5-difluorophenyl)-5-methyl-4H-isoxazole-5-carbonyl]-amino]cyclopent-2-ene-1-carboxylic acid.

Particular preferred isoxazolines of the formula (II) are the following:
ISOX-8, i.e. (II.1.cis), wherein (II.1.cis.A)+(II.1.cis.B) are in a ratio of 50:50: methyl (2RS,4RS)-4-({[(5S)-3-(3,5-difluorophenyl)-5-vinyl-4,5-dihydroisoxazol-5-yl]carbonyl}amino)tetrahydrofuran-2-carboxylate (CAS 2439157-62-5);
(II.1.cis.A): methyl (2S,4S)-4-[[(5S)-3-(3,5-difluorophenyl)-5-vinyl-4H-isoxazole-5-carbonyl]-amino]tetrahydrofuran-2-carboxylate; CAS 2254813-53-9;
(II.1.cis.B): methyl (2R,4R)-4-[[(5S)-3-(3,5-difluorophenyl)-5-vinyl-4H-isoxazole-5-carbonyl]-amino]tetrahydrofuran-2-carboxylate (CAS 2254752-21-9);
(II.5.cis.B): methyl (1S,4R)-4-[[(5S)-3-(3,5-difluorophenyl)-5-vinyl-4H-isoxazole-5-carbonyl]amino]cyclopent-2-ene-1-carboxylate;
(II.8.cis.B): (1S,4R)-4-[[(5R)-3-(3,5-difluorophenyl)-5-methyl-4H-isoxazole-5-carbonyl]amino]cyclopent-2-ene-1-carboxylic acid.

Particular preferred isoxazolines of the formula (II) which, as component B, are constituent of the composition according to the invention, are the isoxazolines of formulae (II.1.cis.A), (II.1.cis.B), (II.5.cis.B), (II.8.cis.B) as defined above and listed below:
(II.1.cis.A): methyl (2S,4S)-4-[[(5S)-3-(3,5-difluorophenyl)-5-vinyl-4H-isoxazole-5-carbonyl]-amino]tetrahydrofuran-2-carboxylate; CAS 2254813-53-9:
(II.1.cis.B): methyl (2R,4R)-4-[[(5S)-3-(3,5-difluorophenyl)-5-vinyl-4H-isoxazole-5-carbonyl]-amino]tetrahydrofuran-2-carboxylate (CAS 2254752-21-9);
(II.5.cis.B): methyl (1S,4R)-4-[[(5S)-3-(3,5-difluorophenyl)-5-vinyl-4H-isoxazole-5-carbonyl]amino]cyclopent-2-ene-1-carboxylate;
(II.8.cis.B): (1S,4R)-4-[[(5R)-3-(3,5-difluorophenyl)-5-methyl-4H-isoxazole-5-carbonyl]amino]cyclopent-2-ene-1-carboxylic acid.

According to a particular preferred embodiment of the invention the composition contains as component B at least one isoxazoline selected from the group consisting of formulae (II.1.cis.A), (II.1.cis.B), (II.5.cis.B) and (II.8.cis.B).

According to another particular preferred embodiment of the invention component B of the composition according to the invention is a mixture of diastereomers consisting of 30-60% of the isoxazoline of formula (II.1.cis.A) and 70-40% of the isoxazoline of formula (II.1.cis.B), both as herein defined.

According to particular another preferred embodiment of the invention component B of the composition according to the invention is a mixture of diastereomers consisting of 40-50% of the isoxazoline of formula (II.1.cis.A) and 60-50% of the isoxazoline of formula (II.1.cis.B), both as herein defined.

According to another particular preferred embodiment of the invention component B of the composition according to the invention is a mixture of diastereomers consisting of 50-60% of the isoxazoline of formula (II.1.cis.A) and 50-40% of the isoxazoline of formula (II.1.cis.B), both as herein defined.

According to another particular preferred embodiment of the invention component B of the composition according to the invention is a racemic mixture consisting of the isoxazoline of formula (II.1.cis.A) and the isoxazoline of formula (II.1.cis.B), both as herein defined.

Particularly preferred isoxazolines of formula (II), which are constituent of the composition according to the invention, are the isoxazolines as defined above; in particular the isoxazolines ISOX-1-ISOX-20 listed below in table ISOX:

TABLE
ISOX

| ISOX-# | isoxazoline of formula (II) |
|---|---|
| ISOX-1 | (II.1.cis) |
| ISOX-2 | (II.1.cis.A) |
| ISOX-3 | (II.1.cis.B) |
| ISOX-4 | (II.1.cis.A) + (II.1.cis.B) in a ratio 30:70 |
| ISOX-5 | (II.1.cis.A) + (II.1.cis.B) in a ratio 35:65 |
| ISOX-6 | (II.1.cis.A) + (II.1.cis.B) in a ratio 40:60 |
| ISOX-7 | (II.1.cis.A) + (II.1.cis.B) in a ratio 45:55 |
| ISOX-8 | (II.1.cis.A) + (II.1.cis.B) in a ratio 50:50 |
| ISOX-9 | (II.1.cis.A) + (II.1.cis.B) in a ratio 55:45 |
| ISOX-10 | (II.1.cis.A) + (II.1.cis.B) in a ratio 60:40 |
| ISOX-11 | (II.3.cis) |
| ISOX-12 | (II.3.cis.A) |
| ISOX-13 | (II.3.cis.B) |
| ISOX-14 | (II.3.cis.A) + (II.3.cis.B) in a ratio 30:70 |
| ISOX-15 | (II.3.cis.A) + (II.3.cis.B) in a ratio 35:65 |
| ISOX-16 | (II.3.cis.A) + (II.3.cis.B) in a ratio 40:60 |
| ISOX-17 | (II.3.cis.A) + (II.3.cis.B) in a ratio 45:55 |
| ISOX-18 | (II.3.cis.A) + (II.3.cis.B) in a ratio 50:50 |
| ISOX-19 | (II.3.cis.A) + (II.3.cis.B) in a ratio 55:45 |
| ISOX-20 | (II.3.cis.A) + (II.3.cis.B) in a ratio 60:40 |

Particularly preferred are compositions 1.1 to 1.80 as defined in table 1:

TABLE 1
(compositions 1.1-1.80)

| comp. # | uracil (I) | isoxazoline (II) |
|---|---|---|
| 1.1 | (I.1) | ISOX-1 |
| 1.2 | (I.1) | ISOX-2 |
| 1.3 | (I.1) | ISOX-3 |
| 1.4 | (I.1) | ISOX-4 |
| 1.5 | (I.1) | ISOX-5 |
| 1.6 | (I.1) | ISOX-6 |
| 1.7 | (I.1) | ISOX-7 |
| 1.8 | (I.1) | ISOX-8 |
| 1.9 | (I.1) | ISOX-9 |
| 1.10 | (I.1) | ISOX-10 |
| 1.11 | (I.1) | ISOX-11 |
| 1.12 | (I.1) | ISOX-12 |
| 1.13 | (I.1) | ISOX-13 |
| 1.14 | (I.1) | ISOX-14 |
| 1.15 | (I.1) | ISOX-15 |
| 1.16 | (I.1) | ISOX-16 |
| 1.17 | (I.1) | ISOX-17 |
| 1.18 | (I.1) | ISOX-18 |
| 1.19 | (I.1) | ISOX-19 |
| 1.20 | (I.1) | ISOX-20 |
| 1.21 | (I.3) | ISOX-1 |
| 1.22 | (I.3) | ISOX-2 |
| 1.23 | (I.3) | ISOX-3 |
| 1.24 | (I.3) | ISOX-4 |
| 1.25 | (I.3) | ISOX-5 |
| 1.26 | (I.3) | ISOX-6 |
| 1.27 | (I.3) | ISOX-7 |
| 1.28 | (I.3) | ISOX-8 |
| 1.29 | (I.3) | ISOX-9 |
| 1.30 | (I.3) | ISOX-10 |
| 1.31 | (I.3) | ISOX-11 |
| 1.32 | (I.3) | ISOX-12 |
| 1.33 | (I.3) | ISOX-13 |
| 1.34 | (I.3) | ISOX-14 |
| 1.35 | (I.3) | ISOX-15 |
| 1.36 | (I.3) | ISOX-16 |
| 1.37 | (I.3) | ISOX-17 |
| 1.38 | (I.3) | ISOX-18 |
| 1.39 | (I.3) | ISOX-19 |
| 1.40 | (I.3) | ISOX-20 |
| 1.41 | (I.4) | ISOX-1 |
| 1.42 | (I.4) | ISOX-2 |
| 1.43 | (I.4) | ISOX-3 |
| 1.44 | (I.4) | ISOX-4 |
| 1.45 | (I.4) | ISOX-5 |
| 1.46 | (I.4) | ISOX-6 |
| 1.47 | (I.4) | ISOX-7 |
| 1.48 | (I.4) | ISOX-8 |
| 1.49 | (I.4) | ISOX-9 |
| 1.50 | (I.4) | ISOX-10 |
| 1.51 | (I.4) | ISOX-11 |
| 1.52 | (I.4) | ISOX-12 |
| 1.53 | (I.4) | ISOX-13 |
| 1.54 | (I.4) | ISOX-14 |
| 1.55 | (I.4) | ISOX-15 |
| 1.56 | (I.4) | ISOX-16 |
| 1.57 | (I.4) | ISOX-17 |
| 1.58 | (I.4) | ISOX-18 |
| 1.59 | (I.4) | ISOX-19 |
| 1.60 | (I.4) | ISOX-20 |
| 1.61 | (I.6) | ISOX-1 |
| 1.62 | (I.6) | ISOX-2 |
| 1.63 | (I.6) | ISOX-3 |
| 1.64 | (I.6) | ISOX-4 |
| 1.65 | (I.6) | ISOX-5 |
| 1.66 | (I.6) | ISOX-6 |
| 1.67 | (I.6) | ISOX-7 |
| 1.68 | (I.6) | ISOX-8 |
| 1.69 | (I.6) | ISOX-9 |
| 1.70 | (I.6) | ISOX-10 |
| 1.71 | (I.6) | ISOX-11 |
| 1.72 | (I.6) | ISOX-12 |
| 1.73 | (I.6) | ISOX-13 |
| 1.74 | (I.6) | ISOX-14 |
| 1.75 | (I.6) | ISOX-15 |
| 1.76 | (I.6) | ISOX-16 |
| 1.77 | (I.6) | ISOX-17 |
| 1.78 | (I.6) | ISOX-18 |
| 1.79 | (I.6) | ISOX-19 |
| 1.80 | (I.6) | ISOX-20 |

In the inventive compositions, the weight ratio of the uracil (I) to the isoxazolin (II) is preferably from 100:1 to 1:100;
more preferably from 50:1 to 1:50;
especially preferred from 25:1 to 1:25;
in particular from 10:1 to 1:10.

Especially preferred are compositions, wherein the weight ratio of the uracil (I) to the isoxazolin (II) is 8:1, 6:1, 5:1, 4:1, 3:1, 2:1, 1.5:1, 1:1, 1:1.5, 1:2, 1:3, 1:4, 1:5, 1:6 or 1:8.

The invention also relates to agrochemical compositions comprising an auxiliary and at least one composition according to the invention.

An agrochemical composition comprises a pesticidally effective amount of at least one composition according to the invention. The term “effective amount” denotes an amount of the active ingredients, which is sufficient for controlling unwanted plants, especially for controlling unwanted plants in crops (i.e. cultivated plants) and which does not result in a substantial damage to the treated plants. Such an amount can vary in a broad range and is dependent on various factors, such as the plants to be controlled, the treated crop or material, the climatic conditions and the specific composition according to the invention used.

The at least one uracil of formula (I) and the at least one isooxazoline of formula (II), their N-oxides or salts can be converted into customary types of agrochemical compositions, e.g. solutions, emulsions, suspensions, dusts, powders, pastes, granules, pressings, capsules, and mixtures thereof.

Examples for agrochemical composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further agrochemical compositions types are defined in the “Catalogue of pesticide formulation types and international coding system”, Technical Monograph No. 2, 6^{th} Ed. May 2008, CropLife International.

The agrochemical compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide.

Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target.

Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for agrochemical composition types and their preparation are:
i) Water-soluble concentrates (SL, LS)
10-60 wt % of a compostions according to the invention and 5-15 wt % wetting agent (e.g. alcohol alkoxylates) are dissolved in water and/or in a water-soluble solvent (e.g. alcohols) ad 100 wt %. The active substance dissolves upon dilution with water.
ii) Dispersible concentrates (DC)
5-25 wt % of a composition according to the invention and 1-10 wt % dispersant (e.g. polyvinylpyrrolidone) are dissolved in organic solvent (e.g. cyclohexanone) ad 100 wt %. Dilution with water gives a dispersion.
iii) Emulsifiable concentrates (EC)
15-70 wt % of a composition according to the invention and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.
iv) Emulsions (EW, EO, ES)
5-40 wt % of a composition according to the invention and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into water ad 100 wt % by means of an emulsifying machine and made into a homogeneous emulsion. Dilution with water gives an emulsion.
v) Suspensions (SC, OD, FS)
In an agitated ball mill, 20-60 wt % of a composition according to the invention are comminuted with addition of 2-10 wt % dispersants and wetting agents (e.g. sodium lignosulfonate and alcohol ethoxylate), 0.1-2 wt % thickener (e.g. xanthan gum) and water ad 100 wt % to give a fine active substance suspension. Dilution with water gives a stable suspension of the active substance. For FS type composition up to 40 wt % binder (e.g. polyvinylalcohol) is added.
vi) Water-dispersible granules and water-soluble granules (WG, SG)
50-80 wt % of a composition according to the invention are ground finely with addition of dispersants and wetting agents (e.g. sodium lignosulfonate and alcohol ethoxylate) ad 100 wt % and prepared as water-dispersible or water-soluble granules by means of technical appliances (e.g. extrusion, spray tower, fluidized bed). Dilution with water gives a stable dispersion or solution of the active substance.
vii) Water-dispersible powders and water-soluble powders (WP, SP, WS)
50-80 wt % of a composition according to the invention are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solution of the active substance.
viii) Gel (GW, GF)
In an agitated ball mill, 5-25 wt % of a a composition according to the invention are comminuted with addition of 3-10 wt % dispersants (e.g. sodium lignosulfonate), 1-5 wt % thickener (e.g. carboxymethylcellulose) and water ad 100 wt % to give a fine suspension of the active substance. Dilution with water gives a stable suspension of the active substance.
iv) Microemulsion (ME)
5-20 wt % of a composition according to the invention are added to 5-30 wt % organic solvent blend (e.g. fatty acid dimethylamide and cyclohexanone), 10-25 wt % surfactant blend (e.g. alcohol ethoxylate and arylphenol ethoxylate), and water ad 100%. This mixture is stirred for 1 h to produce spontaneously a thermodynamically stable microemulsion.
iv) Microcapsules (CS)
An oil phase comprising 5-50 wt % of a composition according to the invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g. diphenylmethene-4,4′-diisocyanate) are dispersed into an aqueous solution of a protective colloid (e.g. polyvinyl alcohol). The addition of a polyamine (e.g. hexamethylenediamine) results in the formation of polyurea microcapsules. The monomers amount to 1-10 wt %. The wt % relate to the total CS composition.
ix) Dustable powders (DP, DS)
1-10 wt % of a composition according to the invention are ground finely and mixed intimately with solid carrier (e.g. finely divided kaolin) ad 100 wt %.
x) Granules (GR, FG)
0.5-30 wt % of a composition according to the invention is ground finely and associated with solid carrier (e.g. silicate) ad 100 wt %. Granulation is achieved by extrusion, spray-drying or the fluidized bed.
xi) Ultra-low volume liquids (UL)
1-50 wt % of a composition according to the invention are dissolved in organic solvent (e.g. aromatic hydrocarbon) ad 100 wt %.
The agrochemical compositions types i) to xi) may optionally comprise further auxiliaries, such as 0.1-1 wt % bactericides, 5-15 wt % anti-freezing agents, 0.1-1 wt % anti-foaming agents, and 0.1-1 wt % colorants.
The agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing.

Methods for applying the compositions according to the present invention, on to plant propagation material, especially seeds include dressing, coating, pelleting, dusting, soaking and in-furrow application methods of the propagation material. Preferably, the compositions according to the present invention are applied on to the plant propagation material by a method such that germination is not induced, e.g. by seed dressing, pelleting, coating and dusting.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:1000 to 1000:1, preferably 1:100 to 100:1.

The user applies the agrochemical composition according to the invention usually from a predosage device, a knapsack sprayer, a spray tank, a spray plane, or an irrigation system.

Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, either individual components of the agrochemical composition according to the invention or partially premixed components, e.g. agrochemical components comprising at least one uracil of formula (I) and at least one isooxazoline of formula (II) may be mixed by the user in a spray tank and further auxiliaries and additives may be added, if appropriate.
In a further embodiment, individual components of the agrochemical composition according to the invention such as parts of a kit or parts of a binary or ternary mixture may be mixed by the user himself in a spray tank and further auxiliaries may be added, if appropriate.
In a further embodiment, either individual components of the agrochemical composition according to the invention or partially premixed components, e.g. components comprising at least one uracil of formula (I) and at least one isooxazoline of formula (II), can be applied jointly (e.g. after tank mix) or consecutively.

Accordingly, a first embodiment of the invention relates to compositions in the form of a agrochemical composition formulated as a 1-component composition comprising the at least one uracil of formula (I) (active compound A) and at least one isoxazoline of formula (II) (active compound B), and also a solid or liquid carrier and, if appropriate, one or more surfactants.

Accordingly, a second embodiment of the invention relates to compositions in the form of an agrochemical composition formulated as a 2-component composition comprising a first formulation (component) comprising the at least one uracil of formula (I), a solid or liquid carrier and, if appropriate, one or more surfactants, and a second component comprising at least one isoxazoline of formula (II), a solid or liquid carrier and, if appropriate, one or more surfactants.

The at least one uracil of formula (I) and the at least one isooxazoline of formula (II) can be formulated and applied jointly or separately, simultaneously or in succession, before, during or after the emergence of the plants. In case of separate application, the order of the application of the active compounds A and B is of minor importance. The only thing important is that the at least one active compound A and the at least one further active compound B are applied in a time frame that allows simultaneous action of the active ingredients on the plants, preferably within a time-frame of at most 42 days, in particular at most 28 days.

The compositions according to the invention are suitable as herbicides. They are suitable as such or as an appropriately formulated composition (agrochemical composition).

The compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants, especially if applied prior to or at planting of the crop. This effect is mainly observed at low rates of application.

The compositions according to the invention have an outstanding herbicidal activity against undesired vegetation, i.e. against a broad spectrum of economically important harmful monocotyledonous and dicotyledonous weeds.

Mentioned below are some representatives of monocotyledonous and dicotyledonous weeds, which can be controlled by the compositions according to the invention without the enumeration being a restriction to certain species.

Preferably the compositions according to the invention are used to control monocotyledonous weeds.

Examples of monocotyledonous weeds on which the compositions according to the invention act efficiently are selected from the genera Hordeum spp., Echinochloa spp., Poa spp., Bromus spp., Digitaria spp., Eriochloa spp., Setaria spp., Pennisetum spp., Eleusine spp., Eragrostis spp., Panicum spp., Lolium spp., Brachiaria spp., Leptochloa spp., Avena spp., Cyperus spp., Axonopris spp., Sorghum spp., and Melinus spp.

Preferred examples of monocotyledonous weeds on which the compositions according to the invention act efficiently are selected from the species Hordeum murinum, Echinochloa crus-galli, Poa annua, Bromus rubens L., Bromus rigidus, Bromus secalinus L., Digitaria sanguinalis, Digitaria insularis, Eriochloa gracilis, Setaria faberi, Setaria viridis, Pennisetum glaucum, Eleusine indica, Eragrostis pectinacea, Panicum miliaceum, Lolium multiflorum, Brachiaria platyphylla, Leptochloa fusca, Avena fatua, Cyperus compressus, Cyperus esculentes, Axonopris offinis, Sorghum halapense, and Melinus repens.

Especially preferred examples of monocotyledonous weeds on which the compositions according to the invention act efficiently are selected from the species Echinochloa spp., Digitaria spp., Setaria spp., Eleusine spp., Lolium ssp. and Brachiarium spp.

Also preferably the compositions according to the invention are used to control dicotyledonous weeds.

Examples of dicotyledonous weeds on which the compositions according to the invention act efficiently are selected from the genera Amaranthus spp., Erigeron spp., Conyza spp., Polygonum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Lamium spp., Kochia spp., Chenopodium spp., Lactuca spp., Malva spp., Ipomoea spp., Brassica spp., Sinapis spp., Urtica spp., Sida spp., Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Vicia spp., Epilobium spp., Cardamine spp., Picris spp., Trifolium spp., Galinsoga spp., Epimedium spp., Marchantia spp., Solanum spp., Oxalis spp., Metricaria spp., Plantago spp., Tribulus spp., Cenchrus spp. Bidens spp., Veronica spp., and Hypochaeris spp.

Preferred examples of dicotyledonous weeds on which the compositions according to the invention act efficiently are selected from the species Amaranthus spinosus, Polygonum convolvulus, Medicago polymorpha, Mollugo verticillata, Cyclospermum leptophyllum, Stellaria media, Gnaphalium purpureum, Taraxacum officinale, Oenothera laciniata, Amsinckia intermedia, Erodium cicutarium, Erodium moschatum, Erigeron bonariensis (Conyza bonariensis), Senecio vulgaris, Lamium amplexicaule, Erigeron canadensis, Polygonum aviculare, Kochia scoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus blitoides, Amaranthus retroflexus, Amaranthus hybridus, Amaranthus lividus, Sida spinosa, Portulaca oleracea, Richardia scabra, Ambrosia artemisiifolia, Calandrinia caulescens, Sisymbrium irio, Sesbania exaltata, Capsella bursa-pastoris, Sonchus oleraceus, Euphorbia maculate, Helianthus annuus, Coronopus didymus, Salsola tragus, Abutilon theophrasti, Vicia benghalensis L., Epilobium paniculatum, Cardamine spp, Picris echioides, Trifolium spp., Galinsoga spp., Epimedium spp., Marchantia spp., Solanum spp., Oxalis spp., Metricaria matriccarioides, Plantago spp., Tribulus terrestris, Salsola kali, Cenchrus spp., Bidens bipinnata, Veronica spp., and Hypochaeris radicata.

Especially preferred examples of dicotyledonous weeds on which the compositions according to the invention act efficiently are selected from the species Amaranthus spp., Ambrosia spp., Chenopodium spp., Ipomoea spp., Kochia spp. and Abutilon spp,

The compositions according to the invention are applied to the plants mainly by spraying the leaves. Here, the application can be carried out using, for example, water as carrier by customary spraying techniques using spray liquor amounts of from about 100 to 1000 I/ha (for example from 300 to 400 I/ha). The herbicidal compositions may also be applied by the low-volume or the ultra-low-volume method, or in the form of microgranules.

Application of the herbicidal compositions according to the present invention can be done before, during and/or after, preferably during and/or after, the emergence of the undesirable plants.

The herbicidal compositions according to the present invention can be applied pre- or post-emergence, together with the seed of a crop plant, or prior to planting a crop plant. It is also possible to apply the compounds and compositions by applying seed, pretreated with a composition of the invention, of a crop plant. If the active compounds A and B and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

In a further embodiment, the composition according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds of the formula (I) according to the invention or the compositions prepared therefrom. Here, the herbicidal compositions can be applied diluted or undiluted.

The term “seed” comprises seed of all types, such as, for example, corns, seeds, fruits, tubers, seedlings and similar forms. Here, preferably, the term seed describes corns and seeds. The seed used can be seed of the useful plants mentioned above, but also the seed of transgenic plants or plants obtained by customary breeding methods.

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

When employed in plant protection, the amounts of active substances applied, i.e. A and B and, if appropriate C, without formulation auxiliaries, are, depending on the kind of effect desired, from 0.001 to 4 kg/ha, preferably from 0.005 to 2 kg/ha, more preferably from 0.01 to 1 kg/ha and in particular from 0.015 to 1 kg per ha.

In another embodiment of the invention, the application rate of A and B and, if appropriate C, is from 0.001 to 3 kg/ha, preferably from 0.005 to 2.5 kg/ha and in particular from 0.01 to 2 kg/ha of active substance (a.s.).

In another preferred embodiment of the invention, the rates of application of the uracil of formula (I) according to the present invention (total amount of uracil of formula (I)) are from 1 g/ha to 500 g/ha, preferably 5 g/ha to 200 g/ha, depending on the control target, the season, the target plants and the growth stage.

In another preferred embodiment of the invention, the application rates of the uracil of formula (I) are in the range from 0.1 g/ha to 5000 g/ha and preferably in the range from 1 g/ha to 2500 g/ha or from 5 g/ha to 500 g/ha.

In another preferred embodiment of the invention, the application rate of the uracil of formula (I) is 0.1 to 1000 g/ha, preferably 1 to 750 g/ha, more preferably 5 to 500 g/ha.

The required application rates of the isoxazoline of formula (II) according to the present invention (total amount of isoxazoline of formula (II)) are from 0.1 g/ha to 3000 g/ha, preferably 1 g/ha to 500 g/ha, depending on the control target, the season, the target plants and the growth stage.

In another preferred embodiment of the invention, the application rates of the uracil of formula (I) are in the range from 0.1 g/ha to 5000 g/ha and preferably in the range from 1 g/ha to 2500 g/ha or from 1 g/ha to 250 g/ha.

In another preferred embodiment of the invention, the application rate of the uracil of formula (I) is 0.1 to 1000 g/ha, preferably 1 to 750 g/ha, more preferably 2 to 200 g/ha.

In the methods of the present invention it is immaterial whether the herbicide uracil of formula (I), and the further herbicide component B are formulated and applied jointly or separately.

In the case of separate application it is of minor importance, in which order the application takes place. It is only necessary, that the herbicide compound A and the herbicide compound B are applied in a time frame that allows simultaneous action of the active ingredients on the plants, preferably within a time-frame of at most 42 days, in particular at most 28 days.

Depending on the application method in question, the compositions according to the invention can additionally be employed in a further number of crop plants for eliminating undesirable plants.

According to the invention all the crop plants (cultivated plants) mentioned herein are understood to comprise all species, subspecies, variants and/or hybrids which belong to the respective cultivated plants, including but not limited to winter and spring varieties, in particular in cereals such as wheat and barley, as well as oilseed rape, e.g. winter wheat, spring wheat, winter barley etc.

For example, corn is also known as Indian corn or maize (Zea mays) which comprises all kinds of corn such as field corn and sweet corn. According to the invention all maize or corn subspecies and/or varieties are comprised, in particular flour corn (Zea mays var. amylacea), popcorn (Zea mays var. everta), dent corn (Zea mays var. indentata), flint corn (Zea mays var. indurata), sweet corn (Zea mays var. saccharata and var. rugosa), waxy corn (Zea mays var. ceratina), amylomaize (high amylose Zea mays varieties), pod corn or wild maize (Zea mays var. tunicata) and striped maize (Zea mays var. japonica).

Further, most soybean cultivars are classifiable into indeterminate and determinate growth habit, whereas Glycine soja, the wild progenitor of soybean, is indeterminate (PNAS 2010, 107 (19) 8563-856). The indeterminate growth habit (Maturity Group, MG 00 to MG 4.9) is characterized by a continuation of vegetative growth after flowering begins whereas determinate soybean varieties (Maturity Group, (MG) 5 to MG 8) characteristically have finished most of their vegetative growth when flowering begins. According to the invention all soybean cultivars or varieties are comprised, in particular indeterminate and determinate cultivars or varieties.

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

Especially preferred crops are crops of cereals, corn, soybeans, rice, oilseed rape, cotton, peanuts, or permanent crops.

The compositions according to the invention can also be used in crops which have been modified by mutagenesis or genetic engineering in order to provide a new trait to a plant or to modify an already present trait.

The term “crops” as used herein includes also (crop) plants which have been modified by mutagenesis or genetic engineering in order to provide a new trait to a plant or to modify an already present trait.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione.

Transgenes which have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csr1-2, gm-hra, S4-HrA, for tolerance to ALS inhibitor herbicides: csr1-2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHG0JG, HCEM485, VCO-Ø1981-5, 676, 678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GH1B119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecticidal proteins to plants. Transgenes which have most frequently been used are toxin genes of Bacillus spec. and synthetic variants thereof, like cry1A, cry1Ab, cry1Ab-Ac, cry1Ac, cry1A.105, cry1F, cry1Fa2, cry2Ab2, cry2Ae, mcry3A, ecry3.1Ab, cry3Bb1, cry34Ab1, cry35Ab1, cry9C, vip3A(a), vip3Aa20. However, also genes of plant origin have been transferred to other plants.

In particular genes coding for protease inhibitors, like CpTI and pinII. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419.

Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athb17, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatb1-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb-4, comprised by soybean event IND-00410-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-qmc.org/GMCropDatabase), as well as in patent applications, like EP3028573 and WO2017/011288.

The use of compositions according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigour, early or delayed ripening, cold or heat tolerance as well as changed amino acid or fatty acid spectrum or content.

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the the compositions according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the compositions according to the invention.

As desiccants, the compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The following examples serve to illustrate the invention. The herbicidal action of the compounds and compositions according to the invention was demonstrated by the following greenhouse experiments:

The culture containers used were plastic pots containing loamy sand with approximately 3.0% of humus as substrate. The seeds of the test plants were sown separately for each species.

For the pre-emergence treatment, the active compounds, suspended or emulsified in water, were applied after sowing by means of finely distributing nozzles. The containers were irrigated gently to promote germination and growth and subsequently covered with transparent plastic hoods until the plants had rooted. This cover caused uniform germination of the test plants unless this was adversely affected by the active compounds.

For the post-emergence treatment, the test plants were grown to a plant height of from 3 to 15 cm, depending on the plant habit, and only then treated with the active compounds which had been suspended or emulsified in water. To this end, the test plants were either sown directly, and grown in the same containers, or they were first grown separately as seedlings and transplanted into the test containers a few days prior to treatment.

Depending on the species, the plants were kept at 10-25 °C and 20-35 °C, respectively. The test period extended over 2 to 4 weeks. During this time, the plants were tended and their response to the individual treatments was evaluated.

Evaluation was carried out using a scale from 0 to 100. 100 means no emergence of the plants, or complete destruction of at least the above-ground parts, and 0 means no damage or normal course of growth. A good herbicidal activity is given at values of at least 70, and very good herbicidal activity is given at values of at least 85.

The respective stated components A and B, and if appropriate, C were formulated as a 5% by weight strength emulsion concentrate and, with addition of the amount of solvent system, introduced into the spray liquor used for applying the active compound. In the examples, the solvent used was water.

In the examples below, using the method of S. R. Colby (1967) “Calculating synergistic and antagonistic responses of herbicide combinations”, Weeds 15, p. 22ff., the value E, which is expected if the activity of the individual active compounds is only additive, was calculated.

E=X+Y−(X·Y/100)
where
X=percent activity using active compound A at an application rate a;
Y=percent activity using active compound B at an application rate b;
E=expected activity (in %) by A+B at application rates a+b.

If the value found experimentally is higher than the value E calculated according to Colby, a synergistic effect is present.

The following active compounds have been tested:

uracil of formula (I.3) Uracils of formula (I):

ISOX-8=isoxazolin of formula (II.1.cis), wherein (II.1.cis.A) and (II.1.cis.B) are in a ratio of 50:50 Isoxazolines of formula (II):
isoxazolin of formula (II.1.cis.A)
isoxazolin of formula (II.1.cis.B)
isoxazolin of formula (II.5.cis.B)
isoxazolin of formula (II.8.cis.B)

The plants used in the greenhouse experiments were of the following species

| Code | Scientific name |
|---|---|
| ABUTH | Abutilon theophrasti |
| AMATA | Amaranthus tamariscinus |
| AVEFA | Avena fatua |
| BRADC | Brachiaria decumbens |
| COMBE | Commenline benghalensis |
| DIGSA | Digitaria sanguinales |
| ECHCG | Echinocloa crus-galli |
| ELEIN | Eleusine indica |
| KCHSC | Kochia scoparia |
| LOLMU | Lolium multiflorum |
| SETFA | Setaria faberi |
| SETVI | Setaria viridis |
| SORHA | Sorghum halepense |

The results of these tests are given in the tables below and demonstrate the synergistic effect of the compositions comprising at least one uracil of the formula (I) and at least one isoxazoline of formula (II).

In this context, a.i. means active ingredient, based on 100% active ingredient.

As indicated the application was post emergent (POST) at the respective growth stage (GS) of the weed.

Assessment was at the indicated days after treatment (DAT).

Example 1: Synergistic herbicidal action of the composition 1.22 (POST; GS 12-16)

| | | | | | | | combination | | |
|---|---|---|---|---|---|---|---|---|---|
| | | | solo application | | | | uracil (I.3) + | | |
| | | | uracil | | isoxazolin | | isoxazolin (II.1.cis.A) | | |
| | | | (I.3) | | (II.1.cis.A) | | | | COLBY |
| entry | | | use rate | % | use rate | % | use rate | % | expected |
| # | DAT | weed | (gai/ha) | activity | (gai/ha) | activity | (gai/ha) | activity | % activity |
| 1 | 7 | AVEFA | 0.5 | 40 | 4 | 25 | 0.5 + 4 | 65 | 55 |
| 2 | 7 | AVEFA | 0.5 | 40 | 2 | 20 | 0.5 + 2 | 60 | 52 |
| 3 | 7 | AVEFA | 0.25 | 35 | 4 | 25 | 0.25 + 4 | 60 | 51 |
| 4 | 7 | AVEFA | 0.25 | 35 | 2 | 20 | 0.25 + 2 | 65 | 48 |
| 5 | 7 | SETFA | 0.5 | 75 | 4 | 70 | 0.5 + 4 | 95 | 93 |
| 6 | 7 | SETFA | 0.5 | 75 | 2 | 70 | 0.5 + 2 | 95 | 93 |
| 7 | 21 | SETFA | 0.5 | 70 | 4 | 85 | 0.5 + 4 | 98 | 96 |
| 8 | 21 | SETFA | 0.5 | 70 | 2 | 75 | 0.5 + 2 | 95 | 93 |
| 9 | 7 | ABUTH | 0.5 | 90 | 2 | 15 | 0.5 + 2 | 95 | 92 |
| 10 | 7 | ABUTH | 0.25 | 85 | 2 | 15 | 0.25 + 2 | 90 | 87 |
| 11 | 21 | ABUTH | 0.25 | 85 | 2 | 0 | 0.25 + 2 | 90 | 85 |

Example 2: Synergistic herbicidal action of the composition 1.23 (POST; GS 12-16)

| | | | | | | | combination | | |
|---|---|---|---|---|---|---|---|---|---|
| | | | solo application | | | | uracil (I.3) + | | |
| | | | uracil | | isoxazolin | | isoxazolin (II.1.cis.B) | | |
| | | | (I.3) | | (II.1.cis.B) | | | | COLBY |
| entry | | | use rate | % | use rate | % | use rate | % | expected |
| # | DAT | weed | (gai/ha) | activity | (gai/ha) | activity | (gai/ha) | activity | % activity |
| 1 | 7 | AVEFA | 0.5 | 40 | 4 | 20 | 0.5 + 4 | 65 | 46 |
| 2 | 7 | AVEFA | 0.5 | 40 | 2 | 10 | 0.5 + 2 | 65 | 46 |
| 3 | 7 | AVEFA | 0.25 | 35 | 4 | 20 | 0.25 + 4 | 55 | 42 |
| 4 | 6 | SETFA | 0.5 | 65 | 0.5 | 55 | 0.5 + 0.5 | 95 | 84 |
| 5 | 6 | SETFA | 0.5 | 60 | 0.25 | 35 | 0.5 + 0.25 | 80 | 74 |
| 6 | 20 | SETFA | 0.5 | 55 | 0.5 | 25 | 0.5 + 0.5 | 98 | 74 |
| 7 | 20 | SETFA | 0.5 | 55 | 0.25 | 20 | 0.5 + 0.25 | 85 | 68 |
| 8 | 20 | DIGSA | 0.5 | 35 | 0.5 | 50 | 0.5 + 0.5 | 80 | 68 |
| 9 | 20 | DIGSA | 0.5 | 35 | 0.25 | 20 | 0.5 + 0.25 | 60 | 48 |
| 10 | 20 | SETVI | 0.25 | 30 | 0.5 | 50 | 0.25 + 0.5 | 85 | 65 |
| 11 | 20 | ELEIN | 0.5 | 35 | 0.25 | 20 | 0.5 + 0.25 | 60 | 48 |
| 12 | 20 | KCHSC | 0.25 | 40 | 0.5 | 15 | 0.25 + 0.5 | 60 | 49 |
| 13 | 6 | ABUTH | 0.5 | 95 | 0.5 | 0 | 0.5 + 0.5 | 98 | 95 |
| 14 | 6 | AMATA | 0.5 | 90 | 0.25 | 15 | 0.5 + 0.25 | 95 | 92 |

Example 3: Synergistic herbicidal action of the composition 3 (POST; GS 12-16)

| | | | | | | | combination | | |
|---|---|---|---|---|---|---|---|---|---|
| | | | solo application | | | | uracil (I.3) + | | |
| | | | uracil | | isoxazolin | | isoxazolin (II.5.cis.B) | | |
| | | | (I.3) | | (II.5.cis.B) | | | | COLBY |
| entry | | | use rate | % | use rate | % | use rate | % | expected |
| # | DAT | weed | (gai/ha) | activity | (gai/ha) | activity | (gai/ha) | activity | % activity |
| 1 | 7 | AVEFA | 0.5 | 40 | 2 | 40 | 0.5 + 2 | 70 | 64 |
| 2 | 6 | ECHCG | 0.5 | 55 | 0.25 | 15 | 0.5 + 0.25 | 65 | 62 |
| 3 | 6 | SETFA | 0.25 | 55 | 0.25 | 40 | 0.25 + 0.25 | 80 | 73 |
| 4 | 20 | SETFA | 0.25 | 55 | 0.25 | 30 | 0.25 + 0.25 | 85 | 69 |
| 5 | 20 | DIGSA | 0.5 | 35 | 0.25 | 35 | 0.5 + 0.25 | 70 | 58 |
| 6 | 6 | COMBE | 0.5 | 90 | 0.5 | 55 | 0.5 + 0.5 | 98 | 96 |
| 7 | 6 | COMBE | 0.5 | 90 | 0.25 | 40 | 0.5 + 0.25 | 98 | 94 |
| 8 | 20 | COMBE | 0.25 | 60 | 0.5 | 70 | 0.25 + 0.5 | 90 | 88 |
| 9 | 6 | AMATA | 0.5 | 90 | 0.25 | 45 | 0.5 + 0.25 | 98 | 95 |
| 10 | 20 | AMATA | 0.5 | 85 | 0.25 | 40 | 0.5 + 0.25 | 100 | 91 |
| 11 | 20 | AMATA | 0.25 | 70 | 0.25 | 40 | 0.25 + 0.25 | 85 | 82 |

Example 4: Synergistic herbicidal action of the composition 4 (POST; GS 12-16)

| | | | | | | | combination | | |
|---|---|---|---|---|---|---|---|---|---|
| | | | solo application | | | | uracil (I.3) + | | |
| | | | uracil | | isoxazolin | | isoxazolin (II.8.cis.B) | | |
| | | | (I.3) | | (II.8.cis.B) | | | | COLBY |
| entry | | | use rate | % | use rate | % | use rate | % | expected |
| # | DAT | weed | (gai/ha) | activity | (gai/ha) | activity | (gai/ha) | activity | % activity |
| 1 | 7 | AVEFA | 0.5 | 40 | 4 | 30 | 0.5 + 4 | 75 | 58 |
| 2 | 7 | AVEFA | 0.5 | 40 | 2 | 30 | 0.5 + 2 | 65 | 58 |
| 3 | 7 | AVEFA | 0.25 | 35 | 4 | 30 | 0.25 + 4 | 60 | 55 |
| 4 | 6 | AVEFA | 0.25 | 35 | 0.5 | 20 | 0.25 + 0.5 | 55 | 48 |
| 5 | 20 | AVEFA | 0.5 | 25 | 1 | 65 | 0.5 + 1 | 85 | 74 |
| 6 | 20 | AVEFA | 0.5 | 25 | 0.5 | 15 | 0.5 + 0.5 | 50 | 36 |
| 7 | 20 | AVEFA | 0.25 | 10 | 1 | 65 | 0.25 + 1 | 75 | 69 |
| 8 | 6 | ECHCG | 0.25 | 40 | 1 | 70 | 0.25 + 1 | 85 | 82 |
| 9 | 6 | SETFA | 0.5 | 65 | 0.5 | 20 | 0.5 + 0.5 | 80 | 72 |
| 10 | 6 | SETFA | 0.25 | 55 | 0.5 | 20 | 0.25 + 0.5 | 70 | 64 |
| 11 | 20 | SETFA | 0.5 | 60 | 1 | 50 | 0.5 + 1 | 85 | 80 |
| 12 | 20 | SETFA | 0.5 | 60 | 0.5 | 30 | 0.5 + 0.5 | 85 | 72 |
| 13 | 20 | SETFA | 0.25 | 55 | 1 | 50 | 0.25 + 1 | 95 | 78 |
| 14 | 20 | SETFA | 0.25 | 55 | 0.5 | 30 | 0.25 + 0.5 | 85 | 69 |
| 15 | 6 | SETVI | 0.5 | 60 | 1 | 10 | 0.5 + 1 | 80 | 64 |
| 16 | 6 | SETVI | 0.25 | 35 | 1 | 10 | 0.25 + 1 | 65 | 42 |
| 17 | 20 | SETVI | 0.5 | 85 | 1 | 20 | 0.5 + 1 | 90 | 88 |
| 18 | 20 | SETVI | 0.25 | 30 | 1 | 20 | 0.25 + 1 | 85 | 44 |
| 19 | 20 | KCHSC | 0.25 | 40 | 1 | 20 | 0.25 + 1 | 65 | 52 |
| 20 | 6 | COMBE | 0.5 | 90 | 1 | 40 | 0.5 + 1 | 98 | 94 |
| 21 | 6 | COMBE | 0.25 | 40 | 0.5 | 15 | 0.25 + 0.5 | 60 | 49 |

Example 5: Synergistic herbicidal action of the composition 1.28 (POST; GS 11-33)

| | | | | | | | combination | | |
|---|---|---|---|---|---|---|---|---|---|
| | | | solo application | | | | uracil (I.3) + | | |
| | | | uracil | | isoxazolin | | isoxazolin ISOX-8 | | |
| | | | (I.3) | | ISOX-8 | | | | COLBY |
| entry | | | use rate | % | use rate | % | use rate | % | expected |
| # | DAT | weed | (gai/ha) | activity | (gai/ha) | activity | (gai/ha) | activity | % activity |
| 1 | 7 | LOLMU | 1.6 | 30 | 3.2 | 50 | 1.6 + 3.2 | 75 | 65 |
| 2 | 20 | LOLMU | 1.6 | 10 | 3.2 | 80 | 1.6 + 3.2 | 90 | 82 |
| 3 | 20 | LOLMU | 0.8 | 10 | 3.2 | 80 | 0.8 + 3.2 | 90 | 82 |
| 4 | 20 | LOLMU | 0.2 | 5 | 3.2 | 80 | 0.2 + 3.2 | 85 | 81 |
| 5 | 7 | AVEFA | 1.6 | 40 | 0.4 | 25 | 1.6 + 0.4 | 85 | 55 |
| 6 | 7 | AVEFA | 0.8 | 25 | 3.2 | 70 | 0.8 + 3.2 | 85 | 78 |
| 7 | 20 | AVEFA | 1.6 | 30 | 3.2 | 90 | 1.6 + 3.2 | 95 | 93 |
| 8 | 20 | AVEFA | 1.6 | 30 | 1.6 | 85 | 1.6 + 1.6 | 98 | 90 |
| 9 | 20 | AVEFA | 1.6 | 30 | 0.4 | 60 | 1.6 + 0.4 | 90 | 72 |
| 10 | 20 | AVEFA | 0.8 | 15 | 3.2 | 90 | 0.8 + 3.2 | 98 | 92 |
| 11 | 20 | AVEFA | 0.8 | 15 | 0.4 | 60 | 0.8 + 0.4 | 75 | 66 |
| 12 | 20 | AVEFA | 0.2 | 10 | 3.2 | 90 | 0.2 + 3.2 | 95 | 91 |
| 13 | 7 | ECHCG | 1.6 | 60 | 0.4 | 15 | 1.6 + 0.4 | 95 | 66 |
| 14 | 20 | ECHCG | 1.6 | 60 | 0.4 | 10 | 1.6 + 0.4 | 90 | 64 |
| 15 | 20 | SETFA | 0.4 | 80 | 0.4 | 20 | 0.4 + 0.4 | 90 | 84 |
| 16 | 20 | SETFA | 0.2 | 15 | 3.2 | 90 | 0.2 + 3.2 | 95 | 92 |
| 17 | 20 | SETFA | 0.2 | 15 | 1.6 | 60 | 0.2 + 1.6 | 85 | 66 |
| 18 | 8 | BRADC | 1.6 | 50 | 3.2 | 50 | 1.6 + 3.2 | 90 | 75 |
| 19 | 8 | BRADC | 1.6 | 50 | 1.6 | 25 | 1.6 + 1.6 | 75 | 63 |
| 20 | 20 | BRADC | 1.6 | 40 | 3.2 | 30 | 1.6 + 3.2 | 75 | 58 |
| 21 | 20 | SORHA | 1.6 | 30 | 1.6 | 60 | 1.6 + 1.6 | 80 | 72 |
| 22 | 20 | SORHA | 0.8 | 30 | 3.2 | 85 | 0.8 + 3.2 | 95 | 90 |
| 23 | 20 | SORHA | 0.4 | 20 | 1.6 | 60 | 0.4 + 1.6 | 90 | 68 |
| 24 | 20 | SORHA | 0.2 | 10 | 3.2 | 85 | 0.2 + 3.2 | 95 | 87 |
| 25 | 20 | SORHA | 0.2 | 10 | 1.6 | 60 | 0.2 + 1.6 | 75 | 64 |
| 26 | 20 | SORHA | 0.2 | 10 | 0.8 | 55 | 0.2 + 0.8 | 70 | 60 |
| 27 | 8 | DIGSA | 0.4 | 30 | 0.4 | 10 | 0.4 + 0.4 | 80 | 37 |
| 28 | 20 | DIGSA | 0.2 | 10 | 3.2 | 60 | 0.2 + 3.2 | 80 | 64 |
| 29 | 8 | SETVI | 1.6 | 95 | 0.8 | 25 | 1.6 + 0.8 | 98 | 96 |
| 30 | 8 | SETVI | 1.6 | 95 | 0.4 | 10 | 1.6 + 0.4 | 98 | 96 |
| 31 | 8 | SETVI | 0.4 | 25 | 0.4 | 10 | 0.4 + 0.4 | 80 | 33 |
| 32 | 8 | SETVI | 0.2 | 20 | 3.2 | 40 | 0.2 + 3.2 | 75 | 52 |
| 33 | 20 | SETVI | 1.6 | 90 | 0.8 | 25 | 1.6 + 0.8 | 95 | 93 |
| 34 | 20 | SETVI | 1.6 | 90 | 0.4 | 10 | 1.6 + 0.4 | 95 | 91 |
| 35 | 20 | SETVI | 0.4 | 10 | 3.2 | 85 | 0.4 + 3.2 | 90 | 87 |
| 36 | 20 | SETVI | 0.4 | 10 | 1.6 | 50 | 0.4 + 1.6 | 90 | 55 |
| 37 | 20 | SETVI | 0.4 | 10 | 0.4 | 10 | 0.4 + 0.4 | 80 | 19 |
| 38 | 20 | SETVI | 0.2 | 5 | 3.2 | 85 | 0.2 + 3.2 | 90 | 86 |
| 39 | 20 | SETVI | 0.2 | 5 | 1.6 | 50 | 0.2 + 1.6 | 90 | 53 |
| 40 | 20 | SETVI | 0.2 | 5 | 0.8 | 25 | 0.2 + 0.8 | 70 | 29 |
| 41 | 7 | ELEIN | 1.6 | 95 | 0.4 | 10 | 1.6 + 0.4 | 98 | 96 |
| 42 | 20 | ELEIN | 1.6 | 90 | 0.4 | 5 | 1.6 + 0.4 | 95 | 91 |
| 43 | 20 | ELEIN | 0.2 | 20 | 3.2 | 70 | 0.2 + 3.2 | 80 | 76 |
| 44 | 7 | KCHSC | 0.8 | 75 | 3.2 | 55 | 0.8 + 3.2 | 98 | 89 |
| 45 | 7 | KCHSC | 0.8 | 75 | 0.8 | 25 | 0.8 + 0.8 | 85 | 81 |
| 46 | 7 | KCHSC | 0.4 | 60 | 0.4 | 10 | 0.4 + 0.4 | 75 | 64 |
| 47 | 20 | KCHSC | 1.6 | 75 | 0.4 | 10 | 1.6 + 0.4 | 95 | 78 |
| 48 | 20 | KCHSC | 0.8 | 55 | 3.2 | 70 | 0.8 + 3.2 | 90 | 87 |
| 49 | 20 | KCHSC | 0.4 | 30 | 1.6 | 60 | 0.4 + 1.6 | 80 | 72 |
| 50 | 20 | KCHSC | 0.2 | 15 | 3.2 | 70 | 0.2 + 3.2 | 85 | 75 |
| 51 | 20 | KCHSC | 0.2 | 15 | 1.6 | 60 | 0.2 + 1.6 | 75 | 66 |
| 52 | 7 | COMBE | 0.2 | 20 | 3.2 | 45 | 0.2 + 3.2 | 75 | 56 |
| 53 | 7 | COMBE | 0.2 | 20 | 1.6 | 45 | 0.2 + 1.6 | 70 | 56 |
| 54 | 20 | COMBE | 1.6 | 95 | 0.4 | 15 | 1.6 + 0.4 | 100 | 96 |
| 55 | 7 | ABUTH | 1.6 | 90 | 3.2 | 15 | 1.6 + 3.2 | 98 | 92 |
| 56 | 7 | ABUTH | 1.6 | 90 | 0.8 | 5 | 1.6 + 0.8 | 100 | 91 |
| 57 | 7 | ABUTH | 1.6 | 90 | 0.4 | 5 | 1.6 + 0.4 | 100 | 91 |
| 58 | 7 | ABUTH | 0.8 | 85 | 3.2 | 15 | 0.8 + 3.2 | 90 | 87 |
| 59 | 7 | ABUTH | 0.8 | 85 | 0.8 | 5 | 0.8 + 0.8 | 90 | 86 |
| 60 | 7 | ABUTH | 0.4 | 85 | 1.6 | 10 | 0.4 + 1.6 | 90 | 87 |
| 61 | 7 | ABUTH | 0.4 | 85 | 0.4 | 5 | 0.4 + 0.4 | 95 | 86 |
| 62 | 7 | ABUTH | 0.2 | 80 | 0.4 | 5 | 0.2 + 0.4 | 85 | 81 |
| 63 | 20 | ABUTH | 1.6 | 90 | 3.2 | 20 | 1.6 + 3.2 | 100 | 92 |
| 64 | 20 | ABUTH | 1.6 | 90 | 0.8 | 5 | 1.6 + 0.8 | 100 | 91 |
| 65 | 20 | ABUTH | 1.6 | 90 | 0.4 | 5 | 1.6 + 0.4 | 100 | 91 |
| 66 | 20 | ABUTH | 0.8 | 80 | 0.8 | 5 | 0.8 + 0.8 | 85 | 81 |
| 67 | 20 | ABUTH | 0.4 | 80 | 0.4 | 5 | 0.4 + 0.4 | 85 | 81 |
| 68 | 7 | AMATA | 0.2 | 70 | 0.4 | 40 | 0.2 + 0.4 | 98 | 82 |
| 69 | 20 | AMATA | 1.6 | 90 | 0.8 | 75 | 1.6 + 0.8 | 100 | 98 |
| 70 | 20 | AMATA | 1.6 | 90 | 0.4 | 35 | 1.6 + 0.4 | 100 | 94 |
| 71 | 20 | AMATA | 0.2 | 40 | 0.4 | 35 | 0.2 + 0.4 | 100 | 61 |

Example 6: Synergistic herbicidal action of the composition 1.68 (POST; GS 11-33)

| | | | | | | | combination | | |
|---|---|---|---|---|---|---|---|---|---|
| | | | solo application | | | | uracil (I.6) + | | |
| | | | uracil | | isoxazolin | | isoxazolin ISOX-8 | | |
| | | | (I.6) | | ISOX-8 | | | | COLBY |
| entry | | | use rate | % | use rate | % | use rate | % | expected |
| # | DAT | weed | (gai/ha) | activity | (gai/ha) | activity | (gai/ha) | activity | % activity |
| 1 | 7 | LOLMU | 1.6 | 15 | 3.2 | 50 | 1.6 + 3.2 | 85 | 58 |
| 2 | 20 | ECHCG | 1.6 | 45 | 0.4 | 10 | 1.6 + 0.4 | 95 | 51 |
| 3 | 20 | BRADC | 1.6 | 40 | 1.6 | 20 | 1.6 + 1.6 | 90 | 52 |
| 4 | 20 | SORHA | 1.6 | 10 | 0.8 | 35 | 1.6 + 0.8 | 90 | 60 |
| 5 | 8 | SETVI | 0.8 | 30 | 3.2 | 40 | 0.8 + 3.2 | 95 | 58 |
| 6 | 20 | DIGSA | 1.6 | 50 | 0.8 | 10 | 1.6 + 0.8 | 100 | 55 |
| 7 | 20 | KCHSC | 0.8 | 55 | 0.4 | 10 | 0.8 + 0.4 | 90 | 60 |

Example 7: Synergistic herbicidal action of the composition 7 (POST; GS 11-33)

| | | | | | | | combination | | |
|---|---|---|---|---|---|---|---|---|---|
| | | | solo application | | | | uracil (I.9) + | | |
| | | | uracil | | isoxazolin | | isoxazolin ISOX-8 | | |
| | | | (I.9) | | ISOX-8 | | | | COLBY |
| entry | | | use rate | % | use rate | % | use rate | % | expected |
| # | DAT | weed | (gai/ha) | activity | (gai/ha) | activity | (gai/ha) | activity | % activity |
| 1 | 20 | ECHCG | 0.4 | 40 | 0.8 | 35 | 0.4 + 0.8 | 80 | 61 |
| 2 | 8 | SETVI | 0.8 | 75 | 0.4 | 10 | 0.8 + 0.4 | 90 | 78 |
| 3 | 7 | KCHSC | 0.4 | 60 | 3.2 | 55 | 0.4 + 3.2 | 90 | 82 |

1. An herbicidal composition comprising
A) at least one uracil of formula (I) 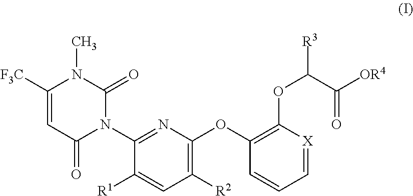
wherein
R¹ is F;
R² is Cl;
R³ is H;
R⁴ is H or C₂H₅; and
X is C;
including an agriculturally acceptable salt thereof;
and
B) at least one isoxazoline of formula (II) selected from the group consisting of (II.1.cis), (II.3.cis), (II.5.cis), (II.6.cis), (II.7.cis), and (II.8.cis): 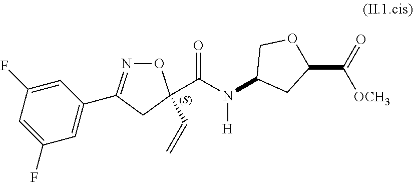 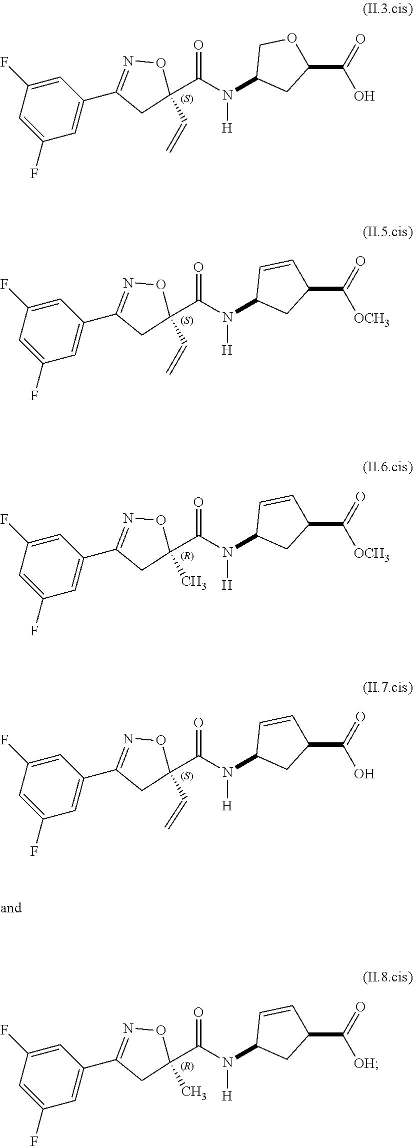
including an agriculturally acceptable salt thereof.

2. The herbicidal composition as claimed in claim 1, comprising at least one isoxazoline of formula (II) selected from the group consisting of (II.1.cis), (II.5.cis), and (II.8.cis).

3. The herbicidal composition a claimed in claim 1 comprising at least one isoxazoline of formula (II) which is the isoxazoline of formula (II.1.cis)

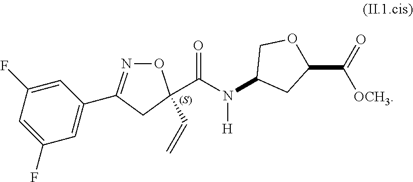

4. The herbicidal composition a claimed in claim 1 comprising at least one isoxazoline selected from formulae (II.1.cis.A) and (II.1.cis.B):

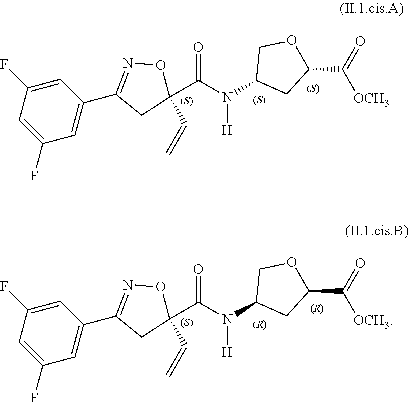

5. The herbicidal composition as claimed in claim 1 comprising as component B a mixture of diastereomers comprising 30-60% of the isoxazoline of formula (II.1.cis.A) and 70-40% of the isoxazoline of formula (II.1.cis.B).
